(19) United States
(12) Patent Application Publication
(10) Pub. No.: US 2024/0402964 A1
(43) Pub. Date: Dec. 5, 2024

(54) IMAGE-FORMING SYSTEM, METHOD, SERVER APPARATUS, AND CLIENT APPARATUS

(71) Applicant: CANON KABUSHIKI KAISHA, Tokyo (JP)

(72) Inventors: Hiroko Kunimoto, Kanagawa (JP); Marehiko Hirajima, Kanagawa (JP); Kengo Kawamoto, Kanagawa (JP); Satoshi Takami, Kanagawa (JP); Kenta Inaba, Irvine, CA (US)

(21) Appl. No.: 18/802,214

(22) Filed: Aug. 13, 2024

Related U.S. Application Data
(63) Continuation of application No. PCT/JP2022/047857, filed on Dec. 26, 2022.

(30) Foreign Application Priority Data
Mar. 9, 2022 (JP) 2022-036408

(51) Int. Cl. G06F 3/12

(52) U.S. Cl. CPC G06F 3/1273; G06F 3/1203; G06F 3/121; G06F 3/1234; G06F 3/1239; G06F 3/1288

(57) ABSTRACT

An image-forming system includes an image-forming apparatus arranged in a user environment and configured to execute a job to form an image on a sheet; a database arranged in a remote environment and configured to store history data of one or more jobs executed by the image-forming apparatus; a control unit configured to control execution of a job at the image-forming apparatus or control charging to a user based on an actual number of consumed sheets calculated based on the history data; a communication unit configured to, when a first job has caused a trouble of image-formation, transmit, in response to an instruction by a user, a modification request for modifying the database so that at least a sheet affected by the trouble is not taken into account in the actual number, the modification request including job-related information.

### CROSS-REFERENCE TO RELATED APPLICATIONS

This application is a Continuation of International Patent Application No. PCT/JP2022/047857, Dec. 26, 2022, which claims the benefit of Japanese Patent Application No. 2022-036408, filed Mar. 9, 2022, both of which are hereby incorporated by reference herein in their entirety.

### BACKGROUND OF THE INVENTION

### Field of the Invention

The present disclosure relates to an image-forming system, a method, a server apparatus, and a client apparatus.

### Background Art

In the field of image-forming apparatuses, there is known a service that allows a user who has signed a contract with a business operator to freely utilize an image-forming apparatus while the contract is effective. In a case of a subscription-type contract, a user pays a fixed usage fee to an operator and is permitted to perform printing as long as an upper limit amount is not exceeded within a predetermined period of time. In a case of a pay-per-use contract, a user pays a usage fee that depends on an amount of printing. The amount of printing actually performed by a user is managed in terms of the number of consumed sheets, for example. Among such services, in order to avoid a situation where printing cannot be performed due to toner depletion or ink depletion or end of lifetime of a component though there is an effective contract, there exists a service in which consumable material is automatically delivered to a user when a remaining amount of the consumable material is detected to be low.

PTL 1 is related to management of an upper limit for an amount of printing per period and proposes a technology which allows a permitted amount of printing for a certain period to be carried over to a subsequent period. PTL 2 proposes a technology that detects fluctuations in characteristic values regarding image-forming operations, such as toner density or surface potential of a photosensitive drum, and automatically skips counting of an amount of printing when it is estimated that degradation in quality of printed materials has occurred. According to the technology of PTL 2, detriment to the user can be avoided because no charge is imposed for printed materials that were output when degradation in quality of printed materials were estimated to occur.

### CITATION LIST

### Patent Literature

PTL 1: Japanese Patent Laid-Open No. 2018-156224
PTL 2: Japanese Patent Laid-Open No. 2002-196636

However, with a mechanism that automatically detects degradation in quality of printed materials, a case where a user subjectively feels dissatisfied with the quality does not always occur simultaneously with a case where quality degradation is automatically detected. The user will be unsatisfied with the service if quality degradation is not detected even though he or she sees a subjective printing trouble in a printed material. On the other hand, if the amount of printing is not counted even when the user is satisfied with the quality, inconvenience occurs in the upper limit management of the printed amount or the charging management.

In light of the foregoing, the present invention aims at realizing a mechanism that can prevent a decrease in user's satisfaction in the case of a printing trouble and, at the same time, appropriately manage the amount of printing.

### SUMMARY OF THE INVENTION

According to an aspect, there is provided an image-forming system including: an image-forming apparatus arranged in a user environment and configured to execute a job to form an image on a sheet; a database arranged in a remote environment and configured to store history data of one or more jobs executed by the image-forming apparatus; a control unit configured to control execution of a job by the image-forming apparatus or control charging to a user of the image-forming apparatus based on an actual number of sheets consumed by the image-forming apparatus calculated based on the history data; and a communication unit configured to, in a case where a first job executed by the image-forming apparatus has caused a trouble of image-formation, transmit, in response to an instruction by a user, a modification request for modifying the database so that at least a sheet affected by the trouble is not taken into account in the actual number, wherein the modification request includes job-related information of the first job. A corresponding method, server apparatus and client apparatus are also provided.

Further features of the present invention will become apparent from the following description of exemplary embodiments with reference to the attached drawings.

### BRIEF DESCRIPTION OF THE DRAWINGS

FIG. 1 is a schematic view illustrating an example of a configuration of an image-forming system according to an embodiment.

FIG. 2A is a first schematic perspective view illustrating an example of an outer appearance of an image-forming apparatus according to an embodiment.

FIG. 2B is a second schematic perspective view illustrating an example of an outer appearance of an image-forming apparatus according to an embodiment.

FIG. 3 is a schematic cross-sectional view illustrating an example of an internal physical configuration of an image-forming apparatus according to an embodiment.

FIG. 4 is a schematic perspective view illustrating an example of a configuration of a toner replenishment path according to an embodiment.

FIG. 5A is a first schematic perspective view illustrating an example of a configuration of a replenishment pack according to an embodiment.

FIG. 5B is a second schematic perspective view illustrating an example of a configuration of a replenishment pack according to an embodiment.

FIG. 6 is an explanatory view illustrating a state in which the replenishment pack of FIG. 4 is connected to a toner receiving unit.

FIG. 7 is a block diagram illustrating an example of a functional configuration of an image-forming apparatus according to an embodiment.

FIG. 8 is a block diagram illustrating an example of a configuration of a user terminal according to an embodiment.

FIG. 9 is a block diagram illustrating an example of a configuration of a management server according to an embodiment.

FIG. 10 is a sequence diagram illustrating an example of a flow of processing at the time of executing an image-forming job.

FIG. 11 is a sequence diagram illustrating a first example of a flow of processing when a printing trouble has occurred.

FIG. 12 is a sequence diagram illustrating a second example of a flow of processing when a printing trouble has occurred.

FIG. 13 is a sequence diagram illustrating a third example of a flow of processing when a printing trouble has occurred.

FIG. 14 is an explanatory diagram illustrating an example of a GUI for managing an account of a subscription contract.

FIG. 15A is an explanatory diagram illustrating an example of a GUI for displaying a list of job history.

FIG. 15B is an explanatory diagram illustrating an example of a GUI for a user to select an item from the list of job history records.

FIG. 15C is an explanatory diagram illustrating an example of a GUI for enabling to request modification to history data of a selected job.

FIG. 15D is an explanatory diagram illustrating an example of a GUI for a user to select trouble image data from a file system.

FIG. 15E is an explanatory diagram illustrating an example of a GUI for completing transmission of a modification request.

FIG. 15F is an explanatory diagram illustrating an example of a GUI displayed after completing transmission of the modification request.

FIG. 15G is an explanatory diagram illustrating an example of a GUI for a user to take an image of a sheet affected by a printing trouble.

FIG. 15H is an explanatory diagram illustrating an example of a GUI for asking a user for confirmation on transmitting image data of a captured image as trouble image data.

FIG. 15I is an explanatory diagram illustrating another example of a GUI for a user to capture an image of a sheet affected by a printing trouble.

FIG. 15J is an explanatory diagram illustrating another example of a GUI for asking a user for confirmation on transmitting image data of a captured image as trouble image data.

FIG. 15K is an explanatory diagram illustrating another example of a GUI for displaying a list of job history records.

FIG. 16 is an explanatory diagram illustrating an example of a GUI for data verification at an operator terminal.

FIG. 17A is an explanatory diagram illustrating a first example of a GUI related to an application for replacement of an image-forming apparatus.

FIG. 17B is an explanatory diagram illustrating a second example of a GUI related to an application for replacement of an image-forming apparatus.

FIG. 17C is an explanatory diagram illustrating a third example of a GUI related to an application for replacement of an image-forming apparatus.

FIG. 17D is an explanatory diagram illustrating a fourth example of a GUI related to an application for replacement of an image-forming apparatus.

FIG. 17E is an explanatory diagram illustrating a fifth example of a GUI related to an application for replacement of an image-forming apparatus.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### 1. Overview of System

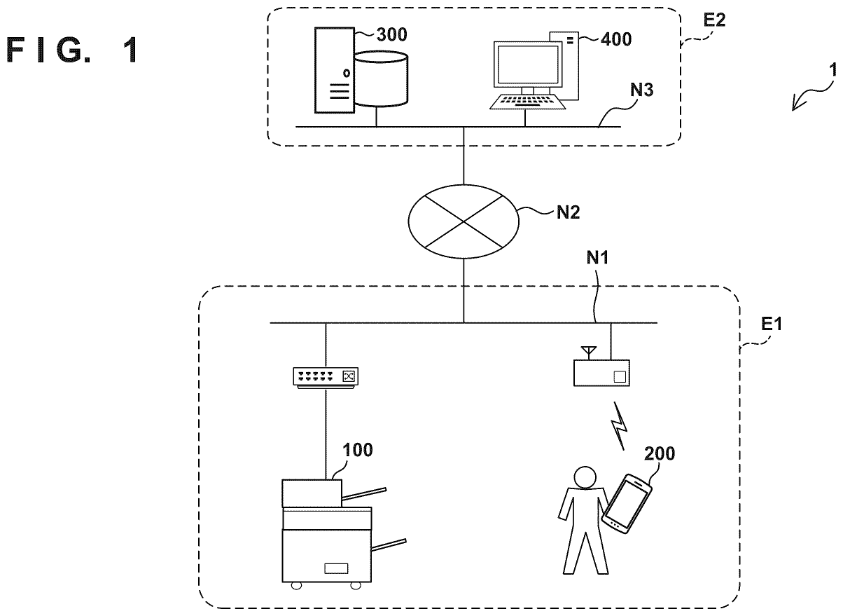

First, an overview of an image-forming system will be described with reference to FIG. 1. FIG. 1 is a schematic view showing an example of a configuration of an image-forming system 1 according to an embodiment. Referring to FIG. 1, the image-forming system 1 includes an image-forming apparatus 100, a user terminal 200, a management server 300, and an operator terminal 400.

The image-forming apparatus 100 is arranged in a user environment E1. The image-forming apparatus 100 may be, for example, one of a printer, a copier, a facsimile receiver, and a multifunction peripheral, and executes a job to form an image on a sheet. Herein, sheets may include various sheet-shaped media of different materials, such as paper, a plastic film, an envelope, and cloth. The image-forming apparatus 100 executes a job in response to a print request from a user as long as a contract signed by the user with a business operator is effective.

The user terminal 200 is a terminal apparatus that is held by the user. The user terminal 200 may be a general-purpose terminal apparatus such as a smartphone, a mobile phone, a personal computer (PC), or a personal digital assistant (PDA). The user terminal 200 provides the user with a user interface (UI) for contract management related to the image-forming apparatus 100 and operation of the image-forming apparatus 100, for example. The image-forming apparatus 100 provides the user with a user interface, too.

In the present specification, the image-forming apparatus 100 and the user terminal 200 that are arranged in the user environment E1 and utilized by the user are also referred to as client apparatuses. The image-forming apparatus 100 and the user terminal 200 are connected to a local network N1. The local network N1 may be a local area network (LAN), for example. The local network N1 is connected to an external network N2 that may be, for example, the Internet or a virtual private network (VPN).

The management server 300 is a server apparatus arranged in a remote environment E2. The management server 300 is connected to the external network N2 through an operator network N3 that may be a LAN. Each of the local network N1, the external network N2, and the operator network N3 may include any types and any number of network apparatuses such as a router, a switch, a gateway, a wireless access point, and a base station, for example. The management server 300 controls execution of jobs at the image-forming apparatus 100 and manages charging to the user in accordance with conditions based on the contract signed by the user with the operator. The management server 300 may be implemented as an application server, a database server, or a cloud server using, for example, a high-performance general-purpose computer.

Note that the functions of the management server 300 to be described in detail below may be provided by a single apparatus, or may be provided by a plurality of physically separate apparatuses in cooperation with each other. A part of a database, which is described as being maintained by the management server 300, may be maintained by an apparatus separate from the management server 300 (for example, another database server).

The operator terminal 400 is connected to the operator network N3, and can access the database managed by the management server 300. The operator terminal 400 may be a general-purpose terminal apparatus such as a PC or a smartphone, or a dedicated terminal apparatus specialized for data management. The operator terminal 400 provides an operator's person in charge with a UI to enable modification to history data of jobs executed by the image-forming apparatus 100, for example.

Though FIG. 1 shows an example where the image-forming system 1 includes one user environment E1 and one remote environment E2, the configuration of the image-forming system 1 is not limited to this example. For example, any numbers of user environments and remote environments may be present in the system, and any number of image-forming apparatuses may be arranged in each user environment.

### 2. Configuration Example of Image-Forming Apparatus

Examples of a physical configuration and a functional configuration of the image-forming apparatus 100 will be described in this section. Though an example where the image-forming apparatus 100 is a monochrome laser printer will be mainly described herein, the technology according to the present disclosure is, of course, applicable also to other types of image-forming apparatuses, such as color laser printers, and ink-jet printers (whether monochrome or color).

### <2-1. Outer Appearance of Apparatus>

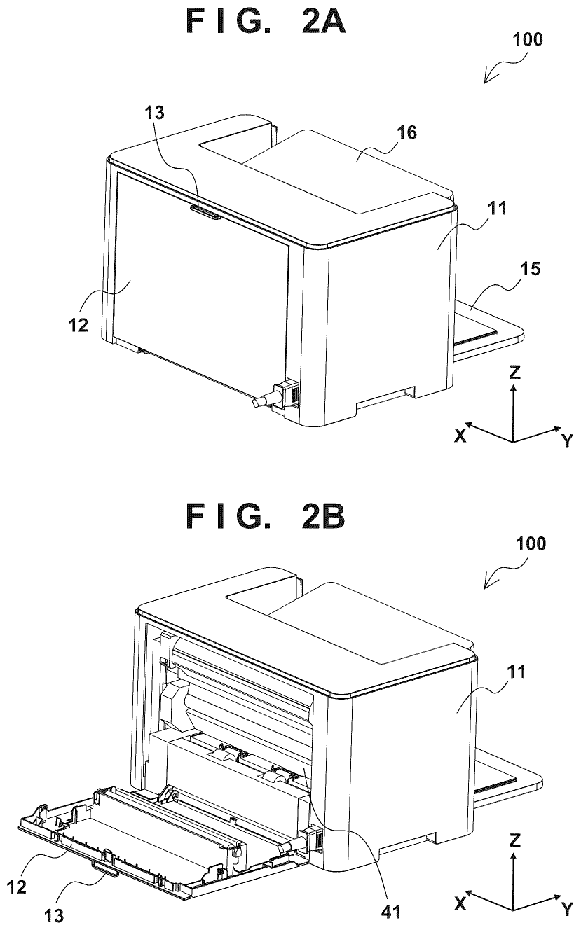

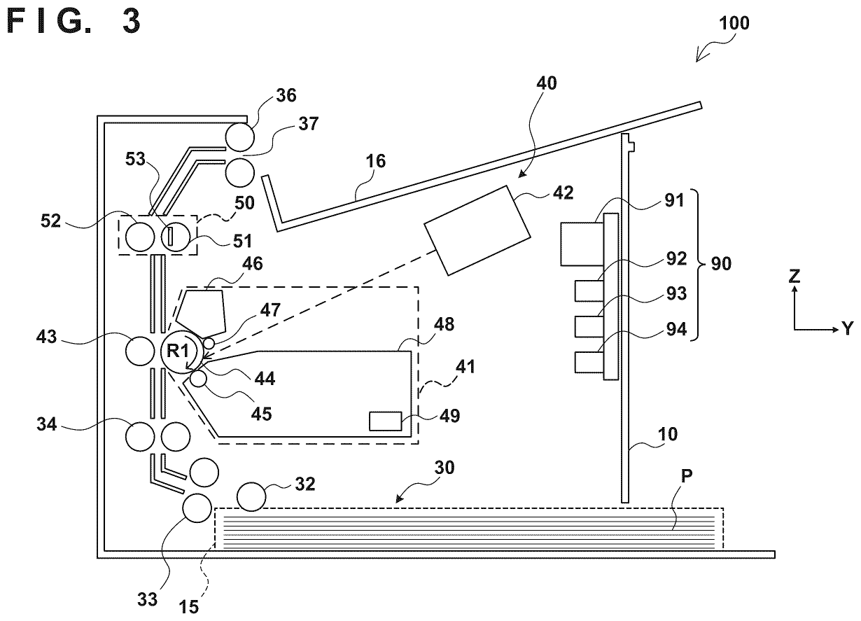

FIGS. 2A and 2B are schematic perspective views illustrating an example of an outer appearance of the image-forming apparatus 100 according to an embodiment. FIG. 3 is a schematic cross-sectional view illustrating an example of an internal physical configuration of the image-forming apparatus 100. In the following descriptions, a height direction of the image-forming apparatus 100 when the image-forming apparatus 100 is installed on a horizontal surface is denoted by Z direction. A direction that is perpendicular to Z direction and parallel to a rotational axis direction (main scanning direction) of a photosensitive drum 44 (to be described below) is denoted by X direction. A direction perpendicular to X and Z directions is denoted by Y direction.

Referring to FIG. 2A, a housing of the image-forming apparatus 100 includes an exterior cover 11, a rear cover 12, a sheet feed tray 15, and a discharge tray 16. The exterior cover 11 physically protects many members inside the image-forming apparatus 100. The rear cover 12 is disposed on a side surface of the image-forming apparatus 100 (the surface at the opposite side from the sheet feed tray 15) in a manner that it is openable and closable. A handle 13 is disposed on the rear cover 12. The user can open the rear cover 12 by grasping the handle 13 of the rear cover 12 to expose a part of a conveyance path through which a sheet is conveyed, thereby performing a maintenance operation such as removal of jamming or replacement of removable member (for example, a process unit 41). FIG. 2A shows a state in which the rear cover 12 is closed, and FIG. 2B shows a state in which the rear cover 12 is open.

### <2-2. Internal Configuration of Apparatus>

Referring to FIG. 3, the image-forming apparatus 100 includes a front cover 10, a feed unit 30, an image-forming unit 40, a fixing unit 50, and processing circuitry 90. The feed unit 30 feeds a sheet toward the image-forming unit 40. The image-forming unit 40 consume toner as a consumable agent to form an image (toner image) on the sheet. The fixing unit 50 fixes the image formed by the image-forming unit 40 to the sheet. The sheet processed by the fixing unit 50 is discharged to the discharge tray 16.

The image-forming unit 40 includes a process unit 41, a scanner unit 42, and a transfer roller 43. The process unit 41 includes the photosensitive drum 44, a developing roller 45, a cleaning unit 46, a charging roller 47, and a preserving unit 48. The process unit 41 may be fixed to the main body of the image-forming apparatus 100 or may be detachable from the main body.

The photosensitive drum 44 is an image carrier, and includes a photosensitive layer made of an organic photosensitive material on a drum-shaped substrate. The photosensitive drum 44 is rotationally driven in a direction R1 in the figure by a motor. The charging roller 47 is applied with a charging voltage by a high-voltage power supply, and pressed against the photosensitive drum 44 to uniformly charge the surface of the photosensitive drum 44. In accordance with the input image data, the scanner unit 42 irradiates the photosensitive drum 44 with a laser beam to expose the surface of the photosensitive drum 44 with light. This exposure forms an electrostatic latent image corresponding to the input image on the surface of the photosensitive drum 44. Note that the scanner unit 42 may irradiate the photosensitive drum 44 with light from an LED array instead of the laser beam.

The developing roller 45 is rotatably supported by the preserving unit 48. The preserving unit 48 preserves toner. Although not shown in FIG. 3, the preserving unit 48 may further include a supply roller that applies toner preserved in the preserving unit 48 to the surface of the developing roller 45. The developing roller 45 is applied with a developing voltage by the high-voltage power supply. When the toner carried on the developing roller 45 contacts the photosensitive drum 44, the toner transfers from the developing roller 45 to the drum surface according to the potential distribution on the surface of the photosensitive drum 44. This develops the electrostatic latent image to be a toner image.

The feed unit 30 includes the sheet feed tray 15, a pickup roller 32, a separation roller pair 33, a conveyance roller pair 34, and a discharge roller pair 36. A bundle of sheets P is loaded in the sheet feed tray 15. The sheet feed tray 15 can be drawn out from the housing of the image-forming apparatus 100. The pickup roller 32 picks up a sheet in the sheet feed tray 15, and feeds the sheet toward the separation roller pair 33. The separation roller pair 33 separates the single sheet from the bundle, and conveys it toward the conveyance roller pair 34. The conveyance roller pair 34 conveys the sheet toward a transfer nip between the transfer roller 43 and the photosensitive drum 44. The transfer roller 43 is applied with a transfer voltage from the high-voltage power supply, and transfers the toner image developed on the surface of the photosensitive drum 44 to the sheet conveyed to the transfer nip.

The sheet onto which the toner image has been transferred is conveyed along the conveyance path and reaches the fixing unit 50. The fixing unit 50 includes a heating roller 51, a pressurizing roller 52, and a fixing heater 53. The heating roller 51 and the pressurizing roller 52 heat and pressurize the sheet as the sheet passes through the nip between the rollers. As a result, the toner particles melt and then fixes, thereby fixing the toner image to the sheet. The sheet that has passed through the fixing unit 50 is discharged from a discharge port 37 to the discharge tray 16 by the discharge roller pair 36. The cleaning unit 46 is disposed in the vicinity of the photosensitive drum 44. The cleaning unit 46 cleans the photosensitive drum 44 by scraping off toner remaining on the surface of the photosensitive drum 44.

The preserving unit 48 includes a remaining amount detection unit 49 that detects the remaining amount of toner in the preserving unit 48. The remaining amount detection unit 49 may include a light emitter that emit light while an agitation member agitates the toner, and a light receiver disposed to face the light emitter, for example. In this case, the remaining amount detection unit 49 may detect the remaining amount of toner based on the ratio of a time during which the light from the light emitter is interrupted to a constant time window. Note that the way in which to detect or estimate the remaining amount of toner is not limited to the above example, and any method may be used for it. For example, the remaining amount detection unit 49 may estimate the remaining amount of toner by detecting electrostatic capacity of the preserving unit 48. Alternatively, the remaining amount of toner may be estimated by subtracting, from the total amount at the time of previous toner replenishment, the total use amount thereafter. The cleaning unit 46 may include a waste toner container that stores toner (waste toner) scraped off from the surface of the photosensitive drum 44, and a detection unit that detects the amount of waste toner in the waste toner container.

The processing circuitry 90 includes electronic components 91, 92, 93, and 94 disposed on a board. For example, the electronic component 91 may be a processor, the electronic component 92 may be a volatile memory, the electronic component 93 may be a nonvolatile memory, and the electronic component 94 may be an input/output device. The input/output device may include a communication interface. When a job requesting image formation is input to the image-forming apparatus 100, an image-forming process based on input image data received from an external computer, for example, is started. The processing circuitry 90 operates as a controller for controlling this image-forming process.

### <2-3. Replenishment of Toner>

In the present embodiment, the image-forming apparatus 100 is assumed to be a replenishment-type image-forming apparatus. That is, the image-forming apparatus 100 forms an image on a sheet using toner that is replenished from a device temporarily connected to the apparatus and is preserved inside the apparatus. Herein, it is assumed that a replenishment pack 150 described below is used for replenishing toner into the image-forming apparatus 100, and a configuration for the replenishment of toner from the replenishment pack 150 will now be described.

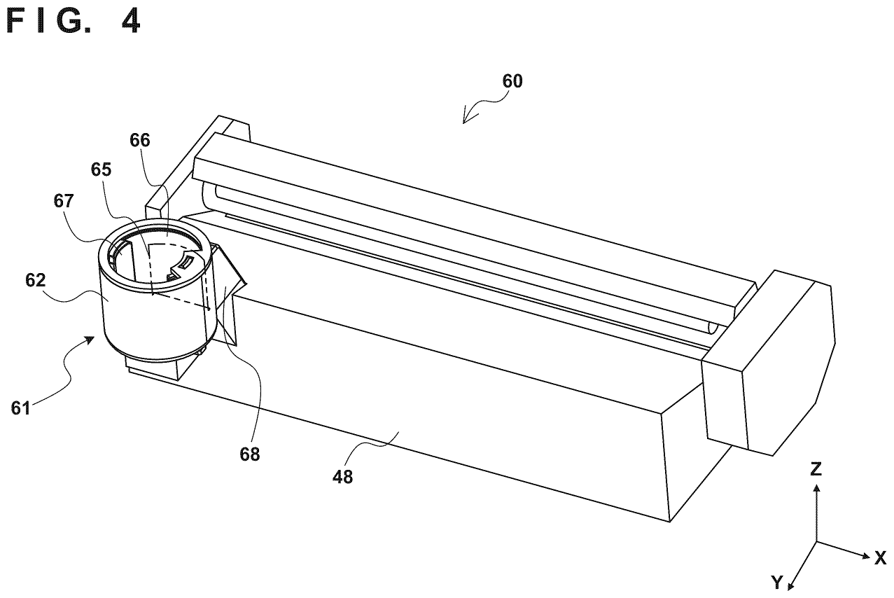

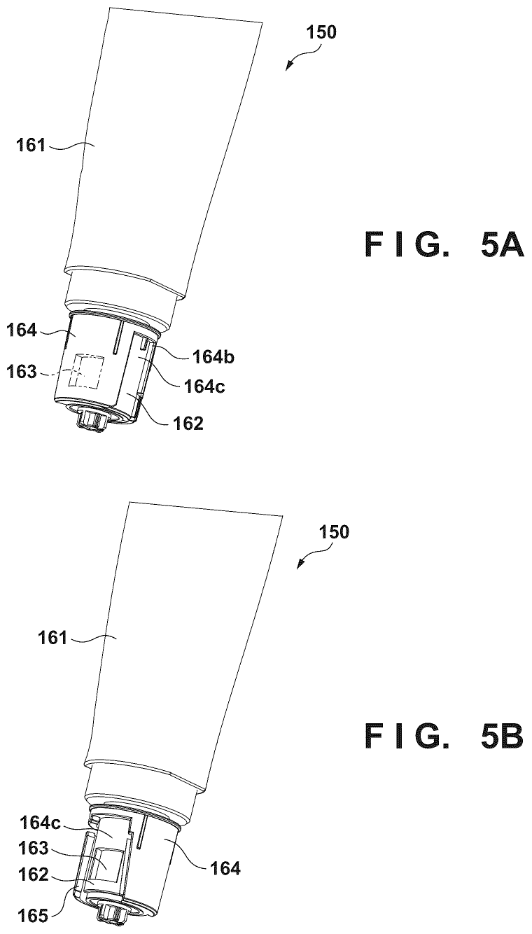

FIG. 4 is a schematic perspective view illustrating an example of a configuration of a toner replenishment path of the image-forming apparatus 100. Referring to FIG. 4, the preserving unit 48 constitutes a part of a toner replenishing unit 60. The toner replenishing unit 60 includes the preserving unit 48 and a toner receiving unit 61. The toner receiving unit 61 includes a cylindrical member 62, a main body shutter 66, and a connecting member 68. Note that the toner receiving unit 61 further includes a ring member 63 described below, but the ring member 63 is not illustrated in FIG. 4 for the purpose of illustrating other constituent elements. An inner space of the cylindrical member 62 communicates with the preserving unit 48 via a side opening 65 and the connecting member 68 which is hollow. The main body shutter 66 serves as an opening and closing mechanism capable of opening and closing the replenishment path of toner from the replenishment pack 150 to the preserving unit 48 illustrated in FIGS. 5A and 5B. That is, when the main body shutter 66 is opened, a replenishment path extending from the replenishment pack 150 to the preserving unit 48 through the connecting member 68 is opened. A protruding part 67 is formed on an inner-side surface of the main body shutter 66.

FIGS. 5A and 5B illustrate an example of a configuration of the replenishment pack 150. Referring to FIG. 5A, the replenishment pack 150 includes a containing part 161, a nozzle 162, and a pack shutter 164. The containing part 161 can be configured as, for example, a hollow tube or pouch for containing toner that is a consumable agent. The containing part 161 is filled with toner in advance. The containing part 161 may be, for example, a plastic bag that can easily deform. However, the containing part 161 is not limited to such examples, and may be made of any material such as a resin, paper, or vinyl, and may have any shape, such as a bottle, cylinder, or box.

The nozzle 162 is an interface portion with the toner receiving unit 61 of the image-forming apparatus 100. The inside of the nozzle 162 communicates with the inside of the containing part 161. An opening 163 for discharging the toner to the outside is formed in a side surface of the nozzle 162. The opening 163 is normally closed by the pack shutter 164.

The pack shutter 164 is a cylindrical member concentric with the nozzle 162, and is disposed on an outer side of the nozzle 162 in a radial direction. The pack shutter 164 has an opening 164c. A part of an edge portion that forms the opening 164c constitutes a drive transmission surface 164b. When replenishing toner, the pack shutter 164 rotates relative to the nozzle 162 such that the opening 163 in the nozzle 162 is aligned with the opening 164c in the pack shutter 164, thereby making it possible to open a toner discharge path which has been closed by the pack shutter 164. As will be described below, the drive transmission surface 164b is a surface that receives a force which rotates the pack shutter 164. FIG. 5A shows a state in which the toner discharge path is closed, and FIG. 5B shows a state in which the toner discharge path is open. A sealing member 165 which normally shields the opening 163 in the nozzle 162 can further be disposed on the inner circumferential surface of the pack shutter 164. The sealing member 165 prevents toner from leaking from the replenishment pack 150 at the time other than the time to replenish toner.

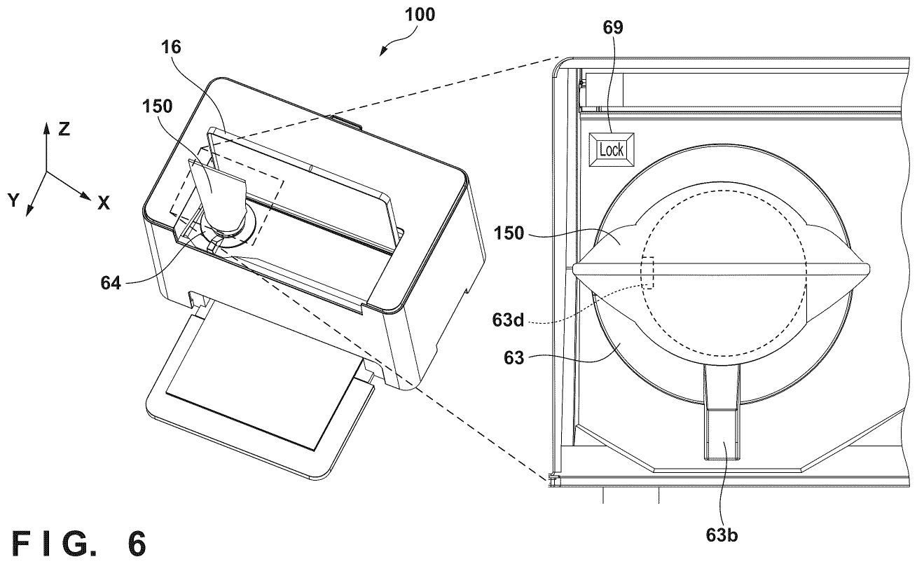

FIG. 6 illustrates a state in which the replenishment pack is connected to the toner receiving unit of FIG. 4. As shown in FIG. 6, the discharge tray 16 is configured to be openable/closable about an opening and closing shaft disposed in the housing along X direction. In the example shown on the left of FIG. 6, the discharge tray 16 is in an open state, and a replenishment port 64 of the toner receiving unit 61 is exposed in this state. A user can connect the replenishment pack 150 to the toner receiving unit 61 by lifting and opening the discharge tray 16 in this manner, and inserting the nozzle 162 of the replenishment pack 150 into the exposed replenishment port 64.

The right side of FIG. 6 shows an enlarged view of a state in which the replenishment pack 150 is connected to the toner receiving unit 61. The ring member 63 surrounding the periphery of the replenishment port 64 is rotatably supported on the top surface of the cylindrical member 62. The ring member 63 includes a lever 63b that is gripped by the user, and a protruding part 63d indicated by a dotted line in the figure. The protruding part 63d engages with the drive transmission surface 164b of the pack shutter 164 of the replenishment pack 150 inserted into the toner receiving unit 61. The drive transmission surface 164b also engages with the protruding part 67 (see FIG. 4) of the main body shutter 66. When the user operates the lever 63b to rotate the ring member 63 about a center axis, a force generated in the rotational direction is transmitted from the protruding part 63d to the drive transmission surface 164b of the pack shutter 164, and is further transmitted from the drive transmission surface 164b to the protruding part 67 of the main body shutter 66. As a result, the main body shutter 66 and the pack shutter 164 of the replenishment pack 150 can rotate in synchronism with the ring member 63, and for example, the toner replenishment path can be opened after 90 degree rotation. When the replenishment path is opened, the toner contained in the containing part 161 of the replenishment pack 150 is injected into the toner receiving unit 61 from the opening 163 in the nozzle 162, and the preserving unit 48 is replenished with the toner through the connecting member 68. Note that the rotation of the ring member 63 can be restricted by a restricting member (not shown) so that the ring member 111 is not rotated exceeding a predetermined upper limit angle.

Although an example where the toner replenishment path is opened by the force in the rotational direction generated when the user operates the lever 63b has been explained above, the replenishment path may alternatively be closed and opened without relying on a user operation. As an example, the image-forming apparatus 100 may include a pack sensor that detects connection of the replenishment pack 150 to the toner receiving unit 61, and a drive motor that generates a driving force for rotating the ring member 63. In this example, the processing circuitry 90 may actuate the drive motor and rotate the ring member 63 with the rotational force of the drive motor to open the replenishment path under a condition that the pack sensor has detected the connection of the replenishment pack 150 to the toner receiving unit 61.

Note that it may be possible to lock or unlock operation or actuation of the opening and closing mechanism described in the previous section by a mechanical, electromagnetic, electrical, or software-based locking mechanism. For example, a mechanism capable of restricting the rotation of the ring member 63 under control of a controller may be employed. The indicator 69 shown on the right of FIG. 6 indicates to the user whether the state of the opening and closing mechanism is a locked state or an unlocked state. When the indicator 69 indicates that the opening and closing mechanism is in the unlocked state, the user can rotate the ring member 63 to open the toner replenishment path.

It should be noted that the image-forming apparatus 100 may be a cartridge-type image-forming apparatus instead of a replenishment-type image-forming apparatus as described above. In a case where the image-forming apparatus 100 is of the cartridge-type, the image-forming apparatus 100 operates in a state in which a toner cartridge containing toner or a process cartridge integrated with the process unit 41 is inserted. In any case, during a period when a contract which the user has signed with the operator is effective, the above-described sheets, replenishment packs or cartridges, and the other consumable materials may be supplied from the operator to the user regularly or in response to a trigger such as detection of a decreased remaining amount. Thus, the user can repeatedly use the image-forming apparatus 100.

### <2-4. Details of Functional Aspect>

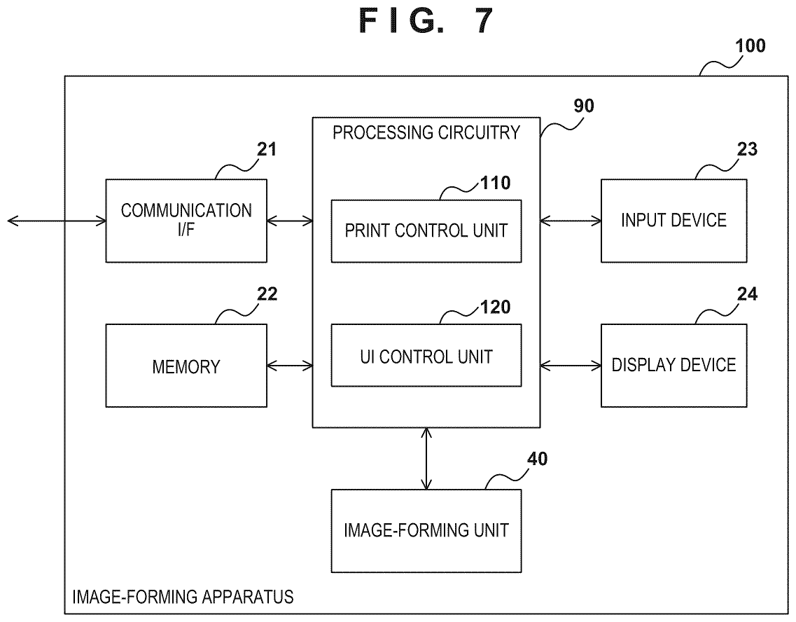

FIG. 7 is a block diagram showing an example of a functional configuration of the image-forming apparatus 100 according to the present embodiment. Referring to FIG. 7, the image-forming apparatus 100 includes a communication interface (I/F) 21, a memory 22, an input device 23, a display device 24, the image-forming unit 40, and the processing circuitry 90.

The communication I/F 21 is a communication unit for the image-forming apparatus 100 to communicate with another apparatus. The communication by the communication I/F 21 is controlled by the processing circuitry 90. For example, the communication I/F 21 communicates with the user terminal 200 present in the user environment E1, and the management server 300 present in the remote environment E2. The communication I/F 21 may be a wired communication interface or a wireless communication interface. If the communication I/F 21 is a wireless communication interface, the communication I/F 21 may be, for example, a WLAN interface or a cellular communication interface. Note that, though only the single communication I/F 21 is shown in FIG. 7, the image-forming apparatus 100 may include a plurality of different communication modules for communicating with the user terminal 200 and the management server 300, respectively. The communication between the image-forming apparatus 100 and the user terminal 200 may also be performed using a communication protocol for connecting peripheral devices, such as Bluetooth® or universal serial bus (USB).

The memory 22 is a storage unit that includes any type of storage medium including a semiconductor memory such as a read only memory (ROM) or random access memory (RAM), an optical disk, or a magnetic disk. The memory 22 may include a non-transitory computer-readable storage medium. The memory 22 stores one or more computer programs to be executed by the processing circuitry 90 and various data. The input device 23 is an operation unit for receiving a user operation and information input. The input device 23 may include one or more of, for example, a touch panel, a keypad, a button, a switch, and a microphone. The display device 24 is a display unit for displaying an image and information. The display device 24 may be constituted by, for example, a liquid crystal display (LCD) or organic light-emitting diodes (OLEDs). The image-forming unit 40 is a unit that perform the image-forming operation described using FIG. 3. The image-forming unit 40 executes an image-forming job to form an image on a sheet under control of a print control unit 110 described below.

From a functional perspective, the electronic components 91, 92, 93, and 94 of the processing circuitry 90 described above may mainly function as the print control unit 110 and a UI control unit 120. The print control unit 110 controls the image-forming operation by the image-forming unit 40. The UI control unit 120 controls interaction with the user via the input device 23 and the display device 24.

In the present embodiment, execution of image-forming jobs at the image-forming apparatus 100 (for example, print jobs and copy jobs) are controlled by the management server 300. For example, when the user instructs execution of a print job at the user terminal 200, the user terminal 200 transmits a print request together with input image data to the management server 300. If the management server 300 permits the print job to be executed, it transmits a print command together with the input image data to the image-forming apparatus 100. Upon receiving the print command by the communication I/F 21, the print control unit 110 controls the image-forming unit 40 to form, on a sheet, an image based on the input image data in accordance with settings of the job.

Once execution of the image-forming job has completed, the print control unit 110 transmits an execution completion report to the management server 300 via the communication I/F 21. The execution completion report may include information such as a job ID identifying the job, execution completion date and time, a latest remaining amount of toner detected by the remaining amount detection unit 49, and the number of consumed sheets. The information reported to the management server 300 in the execution completion reports may be accumulated as history data of jobs in the management server 300. As will be described in detail below, the management server 300 controls the execution of jobs in the image-forming apparatus 100 or controls charging to the user of the image-forming apparatus 100 based on such history data. As an example, in a case where the user has a signed subscription-type contract, an execution of a job at the image-forming apparatus 100 is permitted when an actual number of sheets consumed by the image-forming apparatus 100 within a predetermined period does not exceed an upper limit number. Typically, the upper limit number herein may be determined based on a plan selected by the user in the subscription contract. As another example, in a case where the user has a signed pay-per-use-type contract, the user is charged an amount that depends on the actual number of sheets consumed by the image-forming apparatus 100 within a predetermined period. The print control unit 110 may locally accumulate job history data (for example, in a predetermined storage region of the memory 22), too. The UI control unit 120 may provide the user with a UI that allows the user to browse the history data of one or more jobs executed in the past at the image-forming apparatus 100.

Additionally, the print control unit 110 monitors the remaining amount of toner in the preserving unit 48, and transmits a remaining amount report indicating the remaining amount of toner to the management server 300 regularly or upon detecting a change in the remaining amount. The print control unit 110 may further detect a remaining amount of sheets on the sheet feed tray 15 and a remaining level of another consumable material (for example, a degree of consumption relative to lifetime), and report the detected value to the management server 300. The UI control unit 120 may provide the user with a UI that notifies the user of such statuses including the remaining amount of toner.

Furthermore, the print control unit 110 continuously monitors states of respective units of the image-forming apparatus 100 and detects an occurrence of malfunction or a symptom thereof. In the present specification, a malfunction or a symptom of malfunction is also referred to as simply ‘abnormality’. For example, when the print control unit 110 detects that timing(s) of conveying a sheet is delayed or fluctuates based on a signal from a sensor provided in the conveyance path, it may determine that a component involved in sheet conveyance has deteriorated (for example, a roller has become worn). The print control unit 110 may determine that a roller has become worn based on how many times or how frequently a failure of feed operation such as a slip of a jam has occurred. When an occurrence of an abnormal sound is detected based on a signal from a microphone provided in the housing, the print control unit 110 may determine that a component which has caused the abnormal sound is likely to fail. When the amount of waste toner in the waste toner container reaches a certain ratio relative to its capacity, the print control unit 110 may determine that the life of the process unit 41 is nearing its end. When such an abnormality is detected, the print control unit 110 transmits an abnormality detection report to the management server 300 via the communication I/F 21. The UI control unit 120 also causes details of the detected abnormality to be displayed on a screen of the display device 24.

Note that the communication between the image-forming apparatus 100 and the management server 300 described above may be performed directly between these apparatuses, or may be performed indirectly via the user terminal 200. For example, the print command may be transmitted from the user terminal 200 to the image-forming apparatus 100 in response to permission of the print request, instead of being transmitted directly from the management server 300 to the image-forming apparatus 100. The execution completion report, the remaining amount report, and the abnormality detection report may be transmitted to the management server 300 via the user terminal 200, instead of being transmitted directly from the image-forming apparatus 100 to the management server 300.

Furthermore, though an example has been described here where the print control unit 110 of the image-forming apparatus 100 continuously monitors states of respective units of the image-forming apparatus 100, the management server 300 instead of the image-forming apparatus 100 may monitor the states of the image-forming apparatus 100. For example, the image-forming apparatus 100 may transmit data for state determination (for example, sensor data) to the management server 300, and the management server 300 may analyze the received data to determine whether a malfunction has occurred in the image-forming apparatus 100 or whether there is any symptom of a malfunction.

### 3. Example of Configuration of User Terminal

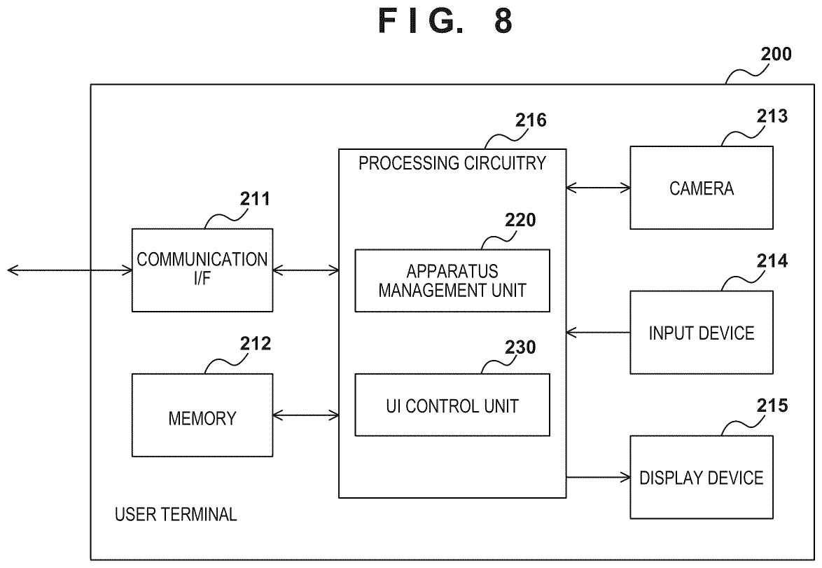

FIG. 8 is a block diagram showing an example of a configuration of the user terminal 200 according to the present embodiment. Referring to FIG. 8, the user terminal 200 includes a communication I/F 211, a memory 212, a camera 213, an input device 214, a display device 215, and processing circuitry 216.

The communication I/F 211 is a communication unit for the user terminal 200 to communicate with another apparatus. The communication by the communication I/F 211 is controlled by the processing circuitry 216. For example, the communication I/F 211 communicates with the image-forming apparatus 100 present in the user environment E1 and the management server 300 present in the remote environment E2. The communication I/F 211 may be a wired communication interface or a wireless communication interface. If the communication I/F 211 is a wireless communication interface, the communication I/F 211 may be, for example, a WLAN interface that communicates with a WLAN access point or a cellular communication interface that communicates with a cellular base station. Although FIG. 8 shows only the single communication I/F 211, the user terminal 200 may include a plurality of different communication modules for communicating with the image-forming apparatus 100 and the management server 300, respectively.

The memory 212 is a storage unit that include any type of storage medium including a semiconductor memory such as a ROM or a RAM, an optical disk, or a magnetic disk. The memory 212 may include a non-transitory computer-readable storage medium. The memory 212 stores one or more computer programs to be executed by the processing circuitry 216 and various data. The camera 213 is a capturing unit that is capable of generating image data of an object by capturing an image of the object. The input device 214 is an operation unit for receiving a user operation and information input. The input device 214 may include one or more of, for example, a touch sensor, a keypad, a keyboard, a pointing device, and a microphone. The display device 215 is a display unit for displaying an image and information. The display device 215 may be constituted by, for example, an LCD or OLEDs.

The processing circuitry 216 may be, for example, a central processing unit (CPU), and provides various functions of the user terminal 200 by executing computer programs stored in the memory 212. More specifically, as shown in FIG. 8, the processing circuitry 216 may function as an apparatus management unit 220 and a UI control unit 230. Note that only the functions related to utilization of the image-forming apparatus 100 by the user will mainly be described in this specification, but the processing circuitry 216 may also provide the user with many other functions that a user terminal generally has. The apparatus management unit 220 and the UI control unit 230 are a set of software modules for managing utilization of the image-forming apparatus 100 operating in cooperation with the management server 300. The apparatus management unit 220 may include driver software for the image-forming apparatus 100. The UI control unit 230 provides the user with various UIs through a web browser or a dedicated application screen.

For example, the UI control unit 230 causes the display device 215 to display an account information input screen in a case where a user account is newly registered, and in a case where there is a change to the user account. When account information is input to the account information input screen, the UI control unit 230 transmits the received account information to the management server 300 via the communication I/F 211. The UI control unit 230 may further provide the user with screens for procedures such as signing a contract, selecting a contract plan, paying a fee, extending a contract period, and canceling the contract.

The apparatus management unit 220 detects the image-forming apparatus 100 as an available apparatus when the image-forming apparatus 100 is installed in the user environment E1 and starts operating. The apparatus management unit 220 presents a list of detected apparatuses to the user on a screen. The apparatus management unit 220 may obtain a status of each apparatus (for example, power on/off, a remaining amount of toner, and the like) and the UI control unit 230 may present status information on a screen of the display device 215.

The UI control unit 230 provides the user with a UI for a print request. For example, the UI control unit 230 causes the display device 215 to display a print dialog when the user select a print menu in an arbitrary application. The UI control unit 230 receives inputs for settings such as the number of printed copies and a color mode via the print dialog, and invokes the apparatus management unit 220. The apparatus management unit 220 obtains a data file to be printed, and transmits a print request for requesting permission on job execution to the management server 300 via the communication I/F 211. If the execution of the job is permitted, a print command is transmitted from the management server 300 to the image-forming apparatus 100 as described above. Then, after the execution of the job is completed at the image-forming apparatus 100, the UI control unit 230 notifies the user of the completion of execution.

When an image-forming job is executed by the image-forming unit 40, a trouble in image formation (hereinafter, referred to as a printing trouble) may occur due to various causes. The printing trouble may be, for example, a faded printed image, a dirty sheet, or a tilted printed image. If, despite a printing trouble, the number of sheets affected by the printing trouble is taken into account in the actual number of sheets affecting contract-based upper limit management or charged amount, the user may feel dissatisfied and an appeal of the service may decrease. Therefore, the UI control unit 230 provides a UI for the user to give an instruction to transmit a modification request for modifying a database so that the sheet(s) affected by a printing trouble is not taken into account in the actual number of sheets when a job has caused the trouble. For example, the UI control unit 230 may cause the display device 215 to display a screen on which history of one or more jobs executed by the image-forming apparatus 100. On this screen, the user is allowed to select the job that has caused a printing trouble and instruct transmission of a modification request. When a first job is selected and transmission of a modification request is instructed by the user, for example, the UI control unit 230 transmits, to the management server 300 via the communication I/F 211, the modification request including job-related information of the first job. In a case where the user has a signed subscription-type contract, the modification request transmitted herein may be a request that at least the sheet(s) affected by the printing trouble be not taken into account in the actual number of sheets to be compared with the upper limit number. In a case where the user has a signed pay-per-use-type contract, the modification request transmitted herein may be a request that at least the sheet(s) affected by the printing trouble be not taken into account in determining the amount to be charged.

The UI control unit 230 may include print image data of a sheet selected by the user as being affected by the printing trouble (hereinafter, referred to as trouble image data) in the above-described modification request to transmit it to the management server 300. The trouble image data may be used for verifying the printing trouble at the operator side, for example.

As an example, the trouble image data may be obtained using the camera 213. In this case, the UI control unit 230 may activate the camera 213, and prompt the user to take an image of the selected sheet. When the user takes an image of the sheet affected by the printing trouble with the camera 213, the UI control unit 230 obtains the image data generated by the camera 213 as the trouble image data.

As another example, the trouble image data may be obtained from the file system. In this case, the UI control unit 230 prompts the user to select a data file of the trouble image data from the file system that can be accessed at the user terminal 200, for example. It is assumed that the user has prepared a data file of the trouble image data in advance, for example, by scanning the sheet using a scanner or taking an image of the sheet using a capturing apparatus other than the user terminal 200. When the user selects the data file of the trouble image data, the UI control unit 230 obtains the selected data file from the file system.

The UI control unit 230 may allow the user to select a method for obtaining the trouble image data in the UI that triggers transmission of the modification request. Options in this case may include a first method to capture an image using the camera and a second method to select a data file from the file system.

In an alteration example, the image-forming apparatus 100 may print certain identification information (for example, a job ID, an apparatus ID, or a user ID) on all sheets in a light color that is difficult to see (for example, using yellow toner) when executing a job. If the sheet is scanned by the user using a scanner, the identification information will appear in read image data and may become visible when the image is reproduced on the operator terminal 400 described below. Verifiability of print image data transmitted with the modification request may be enhanced by such light-colored identification information.

It should be noted that, in this specification, an example where a graphical user interface (GUI) is provided to the user is mainly described, but other types of UIs such as a speech UI or a gesture UI may alternatively be provided. A screen for a GUI may be a screen in any format such as a web page, an input form, or an application screen, for example. Any of the UIs described as being provided by the UI control unit 230 at the user terminal 200 may be provided by the UI control unit 120 at the image-forming apparatus 100. Various examples of the UIs provided to the user will be described in detail using some figures below.

The operator terminal 400 may basically have a similar configuration to that of the user terminal 200. For example, the operator terminal 400 includes a communication I/F for communicating with another apparatus, a memory for storing programs and data, an input device for receiving a user input, a display device for displaying images and information, and processing circuitry for controlling an operation of each device. In this specification, in order to avoid redundancy of descriptions, these components of the operator terminal 400 will not be described in detail.

### 4. Example of Configuration of Management Server

### (1) Basic Configuration

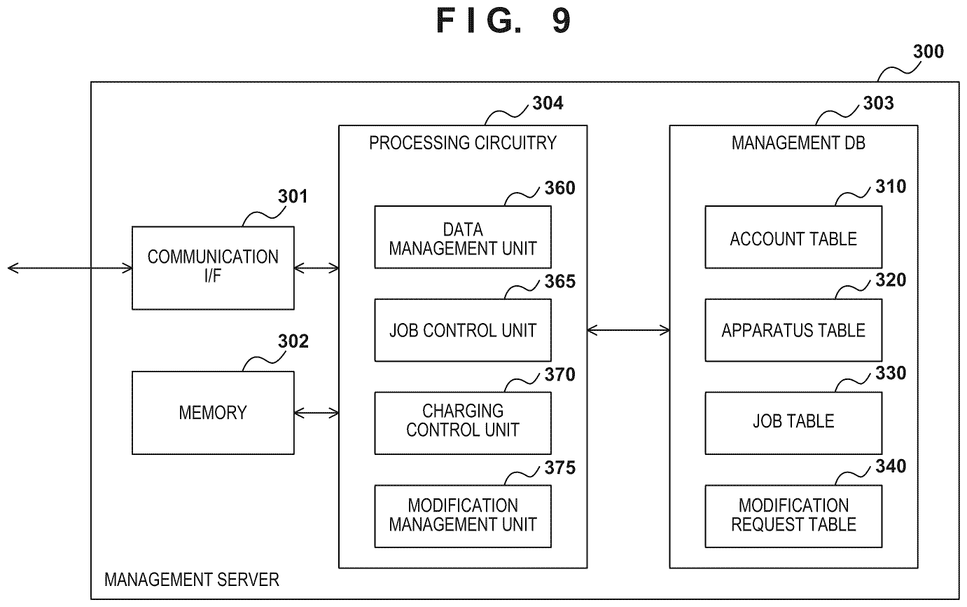

FIG. 9 is a block diagram illustrating an example of a configuration of the management server 300 according to the present embodiment. Referring to FIG. 9, the management server 300 includes a communication I/F 301, a memory 302, a management database (DB) 303, and processing circuitry 304.

The communication I/F 301 is a communication unit for the management server 300 to communicate with another apparatus. For example, the communication I/F 301 communicates with the image-forming apparatuses 100 and the user terminals 200 present in the user environment E1. The communication I/F 301 may be a wired communication interface or a wireless communication interface.

The memory 302 is a storage unit that include any type of storage medium including a semiconductor memory such as a ROM or a RAM, an optical disk, or a magnetic disk. The memory 302 may include a non-transitory computer-readable storage medium. The memory 302 stores one or more computer programs to be executed by the processing circuitry 304 and various data.

The management DB 303 is constituted by tables required for controlling image-forming operations and charging management under the management of the image-forming system 1. More specifically, as shown in FIG. 9, the management DB 303 includes an account table 310, an apparatus table 320, a job table 330, and a modification request table 340.

The processing circuitry 304 may be, for example, a CPU, and provides various functions of the management server 300 by executing computer programs stored in the memory 302. More specifically, as shown in FIG. 9, the processing circuitry 304 may function as a data management unit 360, a job control unit 365, a charging control unit 370, and a modification management unit 375. The data management unit 360 manages the registration and update of data in the management DB 303. The job control unit 365 controls image-forming operation at each image-forming apparatus 100 in accordance with conditions that depend on the content of the contract for each user. The charging control unit 370 controls charging to a user based on a plan selected by the user in a contract. The modification management unit 375 manages modifications to data in the management DB 303 based on above-described modification requests that are received from the user terminal 200 or the image-forming apparatus 100 via the communication I/F 301.

### (2) Configuration Example of Database

The account table 310 of the management DB 303 is a table that holds information concerning accounts of users having contracts signed with the business operator. The account table 310 may include, for example, one or more of the following information items:
“User ID”
“Password”
“Username”
“Address”
“Email Address”
“Payment Information”
   “User ID” is identification information for uniquely identifying each of user accounts. “Password” is used in user authentication when the user logs in to the system. “Username” represents a name of each account. “Address” may be used as a destination when delivering a consumable material from the operator to the user. “Email Address” may be used as a destination address when transmitting a message from the management server 300 to the user. “Payment Information” may be used by the user when electronically paying a fee to the operator based on a contract.

The apparatus table 320 is a table that holds information concerning image-forming apparatuses registered in the image-forming system 1 as a subject of a contract. The apparatus table 320 may include, for example, one or more of the following information items:
“Owner”
“Apparatus ID”
“Contracted Plan”
“Utilization Start Date”
“Upper Limit Number”
“Remaining Amount of Toner”
   “Owner” indicates an account of a user who owns or manages each image-forming apparatus by “User ID” registered in the account table 310. “Apparatus ID” is identification information for uniquely identifying each image-forming apparatus. A pair of “Owner” and “Apparatus ID” indicates an association between each user account and an image-forming apparatus registered as a subject of a contract of the account. Two or more image-forming apparatuses may be associated with one user account. “Contracted Plan” indicates a plan selected in a contract that the user signed with the operator. For example, when a first plan (for example, a regular plan) is selected in a subscription-type contract, execution of a job will be permitted if the actual number of sheets consumed within a predetermined period (for example, one month) does not exceed a first upper limit number. When a second plan (for example, a light plan) is selected, execution of a job will be permitted if the actual number of sheets consumed within a predetermined period does not exceed a second upper limit number that is lower than the first upper limit number. Depending on a contracted plan, various service conditions may be controlled, for example, whether the number of printable sheets can be carried over or borrowed in advance, whether automatic delivery of consumable materials is done, and whether replacement of the apparatus in a case of detection of an abnormality is free of charge or charged. A contracted plan may be a plan not for a subscription-type contract but for a pay-per-use-type contract. “Utilization Start Date” indicates a date on which each image-forming apparatus started to be utilized. “Upper Limit Number” indicates the upper limit of the number of sheets that are allowed to be consumed within the predetermined period for the image-forming apparatus that is a subject of a subscription-type contract. “Remaining Amount of Toner” indicates an amount of toner remaining in each image-forming apparatus by a percentage of its capacity, for example.

Note that, in the present embodiment, information described as being represented by a single information item may be represented substantially by a combination of two or more information items. For example, “Upper Limit Number” may be represented by a combination of: a basic upper limit number indicative of a fixed upper limit number regardless of a period; the number of carried over sheets from the previous month; and the number of borrowed sheets from the next month. The remaining amount information concerning a consumable material may be represented by a combination of an initial amount and a cumulative amount of consumption. In this case, processing of subtracting an amount of consumption from a remaining amount is equivalent to processing of adding an amount of consumption to the cumulative amount of consumption.

The job table 330 is a table that holds history data of one or more image-forming jobs (for example, print jobs and copy jobs) executed at each image-forming apparatus. The job table 330 may include, for example, one or more of the following information items:
“Executing Apparatus”
“Job ID”
“Issuer”
“Filename”
“Execution Date”
“Number of Consumed Sheets”
“Count?”
   “Executing Apparatus” indicates an image-forming apparatus that executed each job by “Apparatus ID” registered in the apparatus table 320. “Job ID” is identification information for uniquely identifying each job. “Issuer” indicates an account of a user who requested execution of each job by “User ID” registered in the account table 310. “Filename” indicates a filename of input image data of each job. The data file of input image data itself may be temporarily stored in the memory 302, and deleted after completion of executing the job, for example. “Execution Date” indicates a date and time at which each job was executed. “Number of Consumed Sheets” indicates the number of sheets consumed in each job. “Count?” is status information for distinguishing whether to take or not to take “Number of Consumed Sheets” of each history record into account in the actual number of consumed sheets that provide a basis for determining whether to permit executing a job or for calculating a charged amount. For example, “Number of Consumed Sheets” of a history record of which “Count?” indicates “YES” is taken into account in the actual number of sheets while “Number of Consumed Sheets” of a history record of which “Count?” indicates “NO” is not taken into account in the actual number of sheets.

The modification request table 340 is a table that holds information concerning modification requests that the management server 300 has received. The modification request table 340 may include, for example, one or more of the following information items:
“Reception ID”
“Reception Date”
“Requester” “Subject
Apparatus”
“Job ID”
“Image Data 1” to “Image Data N”
“Verification Status”
   “Reception ID” is identification information for uniquely identifying each of requests received by the management server 300. “Reception Date” indicates a date on which each request was received by the management server 300. “Requester” indicates an account of a user who requested the modification by “User ID” registered in the account table 310 for each modification request. “Subject Apparatus” indicates an image-forming apparatus that executed the subject job of each modification request by “Apparatus ID” registered in the apparatus table 320. “Job ID” is identification information for identifying a history record of the job table 330 that is the subject of each modification request. “Image Data 1” to “Image Data N” are items for storing N pieces of trouble image data at the maximum that are received in association with each modification request. “Verification Status” indicates a status of verification of trouble image data for each modification request. For example, “Verification Status” may indicate a value of “Unverified”, “Trouble Recognized” or “Trouble Not Recognized”. “Unverified” is an initial value of “Verification Status” and means that verification on the trouble image data has not yet been performed. “Trouble Recognized” means that a printing trouble was actually recognized as a result of verification performed on trouble image data. “Trouble Not Recognized” means that a printing trouble was not recognized as a result of verification performed on trouble image data.

It should be noted that the configuration of the management DB 303 is not limited to the example described here. The management DB 303 may include an additional table. Each table may include further information items and may not include some of the above-described information items.

### (3) Registration of Account Information

The user registers a user account in the system before signing a contract or at the time of signing a contract with the operator. For example, the data management unit 360 receives account information to be registered in the account table 310 from the user terminal 200 via the communication I/F 301, and registers the received account information in the account table 310.

When a contract is established between the user and the operator, the image-forming apparatus 100 designated as a subject of the contract (hereinafter, simply referred to as a subject apparatus) is registered in the apparatus table 320. For example, the subject apparatus may be designated by the user from among apparatuses owned by the user. Alternatively, an apparatus chosen at the operator's side may be designated as the subject apparatus and installed in the user environment E1 after delivery to the user. The data management unit 360 registers, in the apparatus table 320, a record corresponding to a pair of the user ID identifying an account of the user who is the contractor and the apparatus ID identifying the designated subject apparatus in response to establishment of the contract. “Contracted Plan” of the registered record is set to the plan selected by the user.

### (4) Permission or Rejection of Execution of Image-Forming Jobs

Upon a user operation to request execution of an image-forming job at the image-forming apparatus 100 or the user terminal 200, the job control unit 365 receives a print request via the communication I/F 301. The print request may include, for example, the user ID of the user who issued the print request and the apparatus ID of the designated image-forming apparatus 100, as well as other information required to execute the job (for example, the number of copies to be printed and the color mode). In the present embodiment, it is assumed that the print request further includes image data of an image to be printed (that is, input image data). The job control unit 365 derives the number of sheets needed for the job (hereinafter, referred to as a requested number of sheets) and a consumed amount of toner by analyzing information and input image data received in the print request. The consumed amount of toner may be derived by, for example, multiplying the requested number of sheets by a certain coefficient (for example, a fixed coefficient or a coefficient depending on a printing ratio). Then, the job control unit 365 determines whether to permit or reject execution of the requested job on the basis of the derived information. For example, when a print request is received from a user of a subscription contract, the job control unit 365 calculates the actual number of sheets that have already been consumed by the subject apparatus within the latest period from the history data in the job table 330. At this time, the job control unit 365 excludes a history record of which “Count?” indicates “NO” in the job table 330 from calculation of the actual number of sheets. Then, the job control unit 365 permits execution of the job in a case where it is determined that the requested number of sheets does not exceed a difference between the calculated actual number of sheets and the upper limit number. On the other hand, the job control unit 365 rejects execution of the job in a case where it is determined that the requested number of sheets exceeds the difference between the calculated actual number of sheets and the upper limit number. When a print request is received from a user of a pay-per-use contract, the job control unit 365 does not need to perform such calculation of the actual number of sheets and comparison with the upper limit number. However, irrespective of a type of contract, the job control unit 365 may reject execution of a job in a case where the remaining amount of toner in the subject apparatus is insufficient compared to the amount of toner expected to be consumed.

The job control unit 365 transmits a response signal indicating whether the execution of the job is permitted or rejected to the requesting apparatus via the communication I/F 301 as a response to the print request. In the present embodiment, the job control unit 365 transmits a print command to the designated image-forming apparatus 100 when it is determined to permit the execution of the job. The print command includes input image data and other information such as the job ID and the number of copies to be printed. Having received the print command, the image-forming apparatus 100 executes the image-forming job to form an image on a sheet. Upon completing the execution of the job, the image-forming apparatus 100 transmits the above-described execution completion report to the management server 300. When the execution completion report is received from the image-forming apparatus 100, the data management unit 360 adds a history record to the job table 330. At this time, the data management unit 360 sets “Number of Consumed Sheets” of the history record to the value of the number of consumed sheet reported in the execution completion report. The data management unit 360 also sets “Count?” to “YES” that is the initial value. The value “YES” means that “Number of Consumed Sheets” of this record should be taken into account in the actual number of sheets. The data management unit 360 also updates the value of “Remaining Amount of Toner” of the apparatus table 320 to the latest reported value in response to receiving the execution completion report from the image-forming apparatus 100.

### (5) Charging to User

The charging control unit 370 controls charging based on a contract between a user and the operator. For example, the charging control unit 370 charges a regular fee corresponding to a selected plan to a user of a subscription contract for each period. However, in a case where a user has utilized a certain optional service on condition that the user pays an additional fee, the charging control unit 370 may charge the additional fee to the user. For a user of a pay-per-use contract, the charging control unit 370 calculates the actual number of sheets consumed by jobs issued by the user within a latest period from history data in the job table 330. At this time, the charging control unit 370 excludes a history record of which “Count?” indicates “NO” in the job table 330 from calculation of the actual number of sheets. Then, the job control unit 365 charges a fee depending on the calculated actual number of sheets to the user.

### (6) Reception of Modification Request and Modification to History Data

The modification management unit 375 manages modifications to job history data based on modification requests that may be received from the user terminal 200 or the image-forming apparatus 100. As described above, in the present embodiment, the modification request is a request transmitted in response to an instruction from a user in a case where a job executed by the image-forming apparatus 100 has caused a printing trouble. When a modification request is received, the modification management unit 375 assigns a unique reception ID to the modification request, and adds a corresponding record to the modification request table 340. The modification request includes job-related information of a job that caused a printing trouble. The job-related information includes, for example, a user ID for identifying the user who instructed transmission of the modification request or the user who issued the job that caused the printing trouble. Moreover, the job-related information may include an apparatus ID for identifying the apparatus that executed the job, and a job ID for identifying the job. These user ID, apparatus ID and job ID will be the values of “Requester”, “Subject Apparatus” and “Job ID”, respectively, of the record added to the modification request table 340. The value of “Verification Status” of the added record is set to “Unverified” that is the initial value. As each modification request includes one or both of the apparatus ID and the job ID as the job-related information, it will be easy to determine for which apparatus modification to history data (modification to the actual number of sheets) is requested.

The modification request is a request that the history data be modified so that at least a sheet affected by a printing trouble be not taken into account in the actual number of sheets. As an example, the modification management unit 375 may modify the history data by changing a status value of a history record in the job table 330 corresponding to the job ID included in the modification request (for example, changing the value of “Count?” to “NO”). As a result, “Number of Consumed Sheets” of the history record will not be taken into account in the actual number of sheets when the job control unit 365 determines whether or not to permit job execution, or when the charging control unit 370 calculates a fee. As another example, the modification management unit 375 may modify the history data by deleting a history record in the job table 330 corresponding to the job ID included in the modification request. As yet another example, the modification management unit 375 may modify the history data by changing “Number of Consumed Sheets” of a history record in the job table 330 corresponding to the job ID included in the modification request (for example, changing it to zero).

In the present embodiment, the modification request may include print image data of one or more sheets selected by the user as those affected by the printing trouble, that is, trouble image data. The modification management unit 375 stores the trouble image data received with the modification request in “Image Data 1” to “Image Data N” of a corresponding record of the modification request table 340.

In a first practical example, in response to receiving a modification request or receiving trouble image data, the modification management unit 375 may modify the history data in the job table 330 (for example, change the value of “Count?” from “YES” to “NO”) without waiting for data verification. In this case, as the actual number of sheets is decreased immediately after transmission of the modification request, a user who wanted the modification for a valid reason will not feel dissatisfied due to a waiting time until the modification is made. Verification of whether the modification request is reasonable (for example, verification of the trouble image data) may be performed afterward for every modification requests or for some of modification requests. As an example, modification requests subject to the verification may be randomly selected. As another example, modification requests subject to the verification may be selected based on determination on a condition of statistics calculated per user, such as the number or frequency of transmission of the modification requests or the cumulative number of sheets excluded from the actual number of sheets or the like, reaching a threshold.

In a second practical example, for a received modification request, the modification management unit 375 may modify the history data in the job table 330 after it is determined based on verification of the trouble image data that the printing trouble actually occurred. In this case, as the actual number of sheets is avoided from decreasing due to modification requests transmitted even though no printing trouble actually occurred, it is possible to keep determination on whether to permit execution of jobs appropriate or keep fee calculation appropriate.

The data verification in the first and second practical examples may be performed by an operator's person in charge using the operator terminal 400. For example, the modification management unit 375 transmits a message to the operator terminal 400 notifying that a modification request has been received. When the person in charge who receives this notification accesses the management server 300 using a browser or another application on the operator terminal 400, the modification management unit 375 reproduces the trouble image on a screen based on the trouble image data received together with the modification request. The person in charge views the trouble image, judges whether a printing trouble actually occurred, and inputs a result of the judgment via a UI. For example, in the first practical example, in a case where the person in charge inputs a judgment result that no printing trouble actually occurred, the modification management unit 375 changes again the value of “Count?” of the corresponding history record of the job table 330 from “NO” to “YES”. As a result, “Number of Consumed Sheets” of the history record will be taken into account in the actual number of sheets. In the second practical example, in a case where the person in charge inputs a judgment result that a printing trouble actually occurred, the modification management unit 375 changes the value of “Count?” of the corresponding history record of the job table 330 from “YES” to “NO”. As a result, “Number of Consumed Sheets” of the history record will not be taken into account in the actual number of sheets.

In a third practical example, the modification management unit 375 may perform automatic verification on the trouble image data in response to receiving the modification request. The modification management unit 375 may determine that a printing trouble actually occurred, for example, in a case where a predetermined pattern of a trouble image appears in the trouble image data. The modification management unit 375 may classify the image represented by the trouble image data into a normal image or a trouble image by applying the trouble image data to a learned model that was acquired in advance through machine learning using a large number of trouble image samples. When it is determined that a printing trouble actually occurred as a result of the automatic verification, the modification management unit 375 sets the value of “Count?” of the corresponding history record of the job table 330 to “NO”. On the other hand, when it is determined that no printing trouble actually occurred as a result of the automatic verification, the modification management unit 375 keeps the value “YES” of “Count?” of the corresponding history record of the job table 330 unchanged. Such automatic verification may also be performed for some modification requests instead of being performed for all modification requests.

In any of the practical examples, the modification management unit 375 notifies the user who has requested the modification to the history data of the result of the data verification and status change. The modification management unit 375 reflects the result of the data verification in “Verification Status” of the corresponding record of the modification request table 340. For example, the value of “Verification Status” of the modification request for which a printing trouble was recognized as a result of the data verification is changed to “Trouble Recognized”. The value of “Verification Status” of the modification request for which no printing trouble was recognized as a result of the data verification is changed to “Trouble Not Recognized”.

The modification management unit 375 may switch operation to be performed in response to a new modification request from each user based on per-user statistics regarding modification requests in the past calculated from the job table 330 and the modification request table 340. For example, the modification management unit 375 may immediately modify history data in response to a modification request from a user before the number of modification requests received from that user within a fixed period of time reaches a threshold, and after the threshold is reached, impose the data verification prior to modifying history data. This makes it possible to mitigate burden of verification work at the operator's side compared to a case where the data verification is performed whenever a modification request is received, and to shorten a time for a user to wait for the data verification. The modification management unit 375 may reject a modification request after the number of modification requests received from a user within a fixed period of time reaches the threshold. This makes it possible to suppress a situation in which a user immoderately and repeatedly transmits modification requests. As the statistics regarding the modification requests, another measure such as the cumulative number of sheets excluded from the actual number or the like may be used instead of the number of modification requests received. Furthermore, the modification management unit 375 may suggest, to the user, replacement of a member of the image-forming apparatus 100 or replacement of the image-forming apparatus 100 as a whole in a case where it is determined based on statistics regarding modification requests that printing troubles occur at high frequency.

In the present embodiment, examples have been described in which the modification management unit 375 modifies history data in the job table 330 so that the number of all sheets consumed in a job that caused a printing trouble is not taken into account in the actual number. In general, the entire job sometimes needs to be re-executed when there is a printing trouble in some sheets, and thus modification to the actual number in unit of a job can maximally protect against detriment to a user due to printing troubles. In another embodiment, the modification management unit 375 may modify history data so that the number of some of sheets consumed in a job that caused a printing trouble is not taken into account in the actual number. For example, consider a case where L sheets were consumed in a job but trouble image data for M sheets (M<L, L and M are integer numbers) has been received. In this case, the modification management unit 375 may exclude only M sheets from the actual number of sheets (for example, the number M may be subtracted from the value of “Number of Consumed Sheets” of the job table 330). Alternatively, the number of sheets to be excluded from the actual number may be simply designated by a user when transmitting a modification request. In this manner, allowing to modify the actual number in a unit of sheet makes it possible to adjust the actual number of sheets more accurately to an appropriate value depending on how the printing trouble actually occurred.

### 5. Examples of Processing Flows

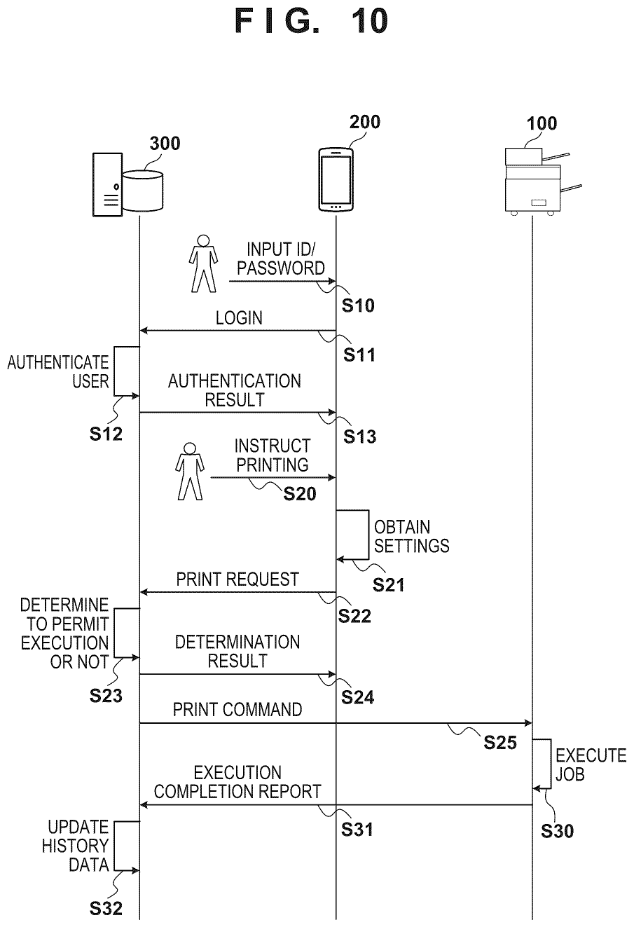

This section will describe using FIGS. 10 to 13 several examples of flows of processing that may be performed in the image-forming system 1 according to the embodiments described above. Note that, in the following descriptions, a processing step will be abbreviated as S (Step).

### <5-1. Execution of Image-Forming Jobs>

FIG. 10 is a sequence diagram illustrating an example of a flow of schematic processing at the time of executing an image-forming job. The image-forming apparatus 100, the user terminal 200, and the management server 300 are mainly involved in the processing illustrated in FIG. 10.

First, in S10, a user inputs a user ID and a password to a login screen. In S11, the apparatus management unit 220 of the user terminal 200 transmits the input user ID and password to the management server 300. In S12, the management server 300 performs user authentication based on the user ID and password received from the user terminal 200. It is assumed here that the user authentication is successful and the login to the system is established. In S13, the management server 300 notifies the user terminal 200 of the result of the user authentication. The subsequent processing of FIG. 10 is performed while the login session continues.

In S20, the user instructs printing at the user terminal 200. In S21, the apparatus management unit 220 of the user terminal 200 obtains necessary settings (for example, an apparatus ID of an apparatus to execute the job, the number of copies to be printed, a color mode, and a filepath) via a print dialog displayed by the display device 215. In S22, the apparatus management unit 220 transmits a print request that may include setting information indicating the settings obtained in S21 and input image data. The apparatus management unit 220 may transmit an original data file as the input image data as-is, or transmit it after conversion into a file format that is suitable for printing (for example, PostScript format).

Having received the print request, the job control unit 365 of the management server 300 determines, in S23, whether to permit execution of the job or not. For example, the job control unit 365 may permit execution of the job, for a user having a subscription-type contract, when it is determined that the actual number of sheets consumed within a predetermined period will not exceed the upper limit number even if the requested job is executed. Herein, it is assumed that execution of the requested job is permitted. In S24, the job control unit 365 transmits a response signal indicating that execution of the job is permitted to the user terminal 200 as a response to the print request.

In S25, the job control unit 365 of the management server 300 that has determined to permit the execution of the job transmits a print command including the input image data to the image-forming apparatus 100 designated by the user. Having received the print command, the print control unit 110 of the image-forming apparatus 100 causes, in S30, the image-forming unit 40 to execute the image-forming job. The image-forming unit 40 forms, on a sheet, an image based on the input image data in accordance with settings designated in the print command. Upon completing the execution of the job, the print control unit 110 transmits to the management server 300, in S31, an execution completion report that may include information such as the number of consumed sheets and the latest remaining amount of toner, for example. Having received the execution completion report, the data management unit 360 of the management server 300 updates, in S32, the history data stored in the job table 330.

### <5-2. Modification to History Data>

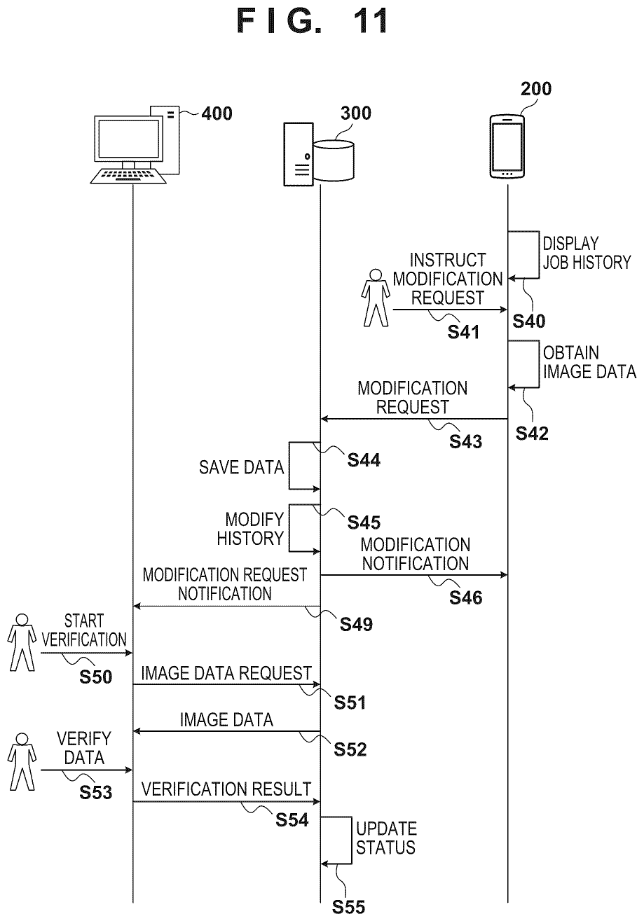

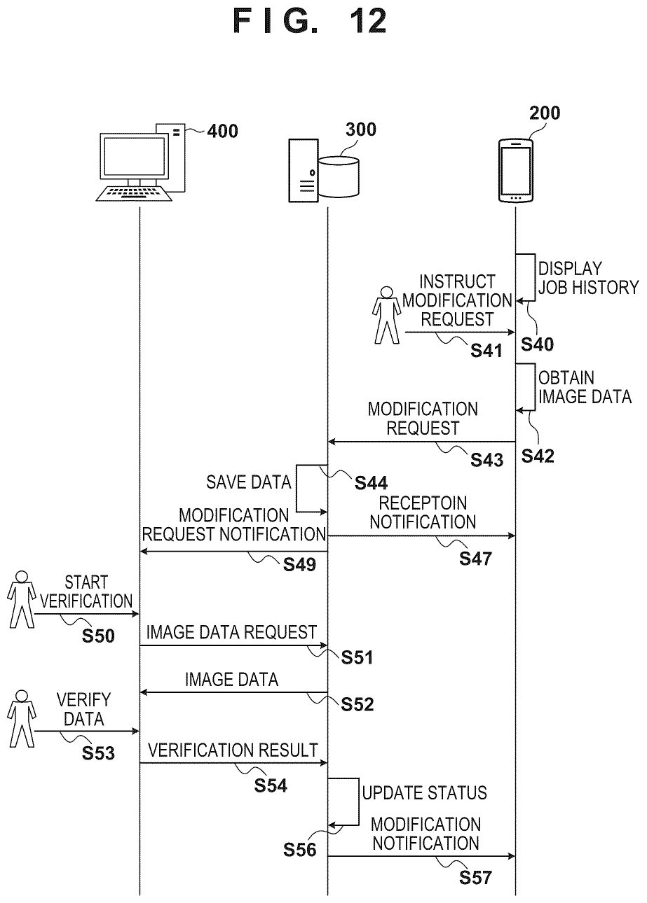

FIGS. 11 to 13 illustrate respective examples of flows of processing when a printing trouble has occurred due to execution of a job. The user terminal 200, the management server 300, and the operator terminal 400 are involved in the illustrated processing in the first practical example of FIG. 11 and the second practical example of FIG. 12. The operator terminal 400 is not involved in the processing in the third practical example of FIG. 13.

In each practical example, prior to the illustrated processing, it is assumed that history data of jobs executed in the past at the image-forming apparatus 100 has been provided from the modification management unit 375 of the management server 300 to the user terminal 200 in response to the user invoking a job history screen. Note that, though an example is described here in which transmission of a modification request is triggered at the user terminal 200, the UI control unit 230 in the following descriptions may be interpreted as the UI control unit 120 of the image-forming apparatus 100 in a case where transmission of a modification request is triggered at the image-forming apparatus 100.

### (1) First Practical Example

Referring to FIG. 11, first, in S40, the UI control unit 230 of the user terminal 200 causes a list of job execution history records to be displayed on the job history screen based on the history data provided from the management server 300. In S41, the user selects the job that has caused a printing trouble on the screen and instructs transmission of a modification request. In S42, the UI control unit 230 obtains trouble image data by activating the camera 213 to cause the user to take an image of the sheet affected by the printing trouble, or causing the user to select a file from the file system. Next, in S43, the UI control unit 230 transmits a modification request for modifying history data of the job that has caused the printing trouble to the management server 300 via the communication I/F 211 together with the obtained trouble image data.

The modification management unit 375 of the management server 300 receives the modification request via the communication I/F 301 and, in S44, adds a record to the modification request table 340 to save a reception ID, job-related information and the trouble image data of the modification request. In the present practical example, the modification management unit 375, in S45, modifies a history record in the job table 330 identified by the job ID designated in the modification request so that “Number of Consumed Sheets” of that record is not taken into account in the actual number of sheets. Next, in S46, the modification management unit 375 transmits a modification notification to the user terminal 200 notifying that the history record has been modified.

Further, in S49, the modification management unit 375 transmits a modification request notification to the operator terminal 400 notifying that the modification request has been received. The operator's person in charge becomes aware of this modification request notification at the operator terminal 400 and, in S50, accesses the management server 300 to start data verification. In S51, the operator terminal 400 transmits, to the management server 300, a request for the trouble image data associated with the modification request identified by the reception ID designated by the person in charge. In S52, the modification management unit 375 of the management server 300 transmits the trouble image data to the operator terminal 400 in response to the request from the operator terminal 400. In S53, the person in charge verifies the trouble image data by viewing the trouble image displayed on a screen of the operator terminal 400, judges whether a printing trouble actually occurred, and inputs a result of the judgment to the operator terminal 400. In S54, the operator terminal 400 transmits the result of the data verification to the management server 300 based on the input from the person in charge.

In S55, the modification management unit 375 of the management server 300 updates the management DB 303 based on the result of the data verification notified from the operator terminal 400. For example, in a case where a judgment result that no printing trouble actually occurred is notified, the modification management unit 375 changes the value of “Count?” of the corresponding history record of the job table 330 from “NO” to “YES”. The modification management unit 375 reflects the result of the data verification in “Verification Status” of the corresponding record of the modification request table 340.

### (2) Second Practical Example

Referring to FIG. 12, the processing steps of $40 to S43 in the second practical example are the same as those processing steps in the first practical example described using FIG. 11. The modification management unit 375 of the management server 300 receives a modification request via the communication I/F 301 from the user terminal 200 and, in S44, adds a record to the modification request table 340 to save a reception ID, job-related information and trouble image data of the modification request. Next, in the present practical example, in S47, the modification management unit 375 transmits a reception notification to the user terminal 200 notifying that the modification request has been received. Further, in S49, the modification management unit 375 transmits a modification request notification to the operator terminal 400 notifying that data verification needs to be performed as the modification request has been received.

The operator's person in charge becomes aware of the modification request notification at the operator terminal 400 and, in S50, accesses the management server 300 to start data verification. In S51, the operator terminal 400 transmits, to the management server 300, a request for the trouble image data associated with the modification request identified by the reception ID designated by the person in charge. In S52, the modification management unit 375 of the management server 300 transmits the trouble image data to the operator terminal 400 in response to the request from the operator terminal 400. In S53, the person in charge verifies the trouble image data by viewing the trouble image displayed on a screen of the operator terminal 400, judges whether a printing trouble actually occurred, and inputs a result of the judgment to the operator terminal 400. In S54, the operator terminal 400 transmits the result of the data verification to the management server 300 based on the input from the person in charge.

In S56, the modification management unit 375 of the management server 300 updates the management DB 303 based on the result of the data verification notified from the operator terminal 400. For example, in a case where a judgment result that a printing trouble actually occurred is notified, the modification management unit 375 changes the value of “Count?” of the corresponding history record of the job table 330 from “YES” to “NO”. The modification management unit 375 reflects the result of the data verification in “Verification Status” of the corresponding record of the modification request table 340. Then, in S57, the modification management unit 375 transmits a modification notification to the user terminal 200 notifying that the history data has been modified (or is not modified because no trouble has been recognized in the data verification).

### (3) Third Practical Example

Referring to FIG. 13, the processing steps of S40 to S43 in the third practical example are the same as those processing steps in the first practical example described using FIG. 11. The modification management unit 375 of the management server 300 receives a modification request via the communication I/F 301 from the user terminal 200 and, in S44, adds a record to the modification request table 340 to save a reception ID, job-related information and trouble image data of the modification request. Next, in the present practical example, in S60, the modification management unit 375 performs automatic verification on the trouble image data received with the modification request to determine whether a printing trouble actually occurred or not. Next, in S61, the modification management unit 375 updates the management DB 303 based on the result of the automatic verification. For example, in a case where it is determined that a printing trouble actually occurred, the modification management unit 375 changes the value of “Count?” of the corresponding history record of the job table 330 from “YES” to “NO”. On the other hand, in a case where it is determined that no printing trouble actually occurred, the modification management unit 375 keeps the value “YES” of “Count?” of the corresponding history record of the job table 330 unchanged. The modification management unit 375 reflects the result of the data verification in “Verification Status” of the corresponding record of the modification request table 340. Then, in S62, the modification management unit 375 transmits a modification notification to the user terminal 200 notifying that the history data has been modified (or is not modified because no trouble has been recognized in the data verification).

Such automatic verification in the third practical example may be combined with the visual-check verification in the first and second practical examples described above. For example, the visual-check verification by an operator's person in charge may be performed only for modification requests for which it has been determined that a printing trouble has not occurred as a result of the automatic verification by the modification management unit 375. This allows to mitigate the workload of the operator's person in charge compared to the first and second practical examples.

### 6. Examples of GUI

Several examples of GUIs provided to a user in the present embodiment will be described in this section.

### <6-1. Account Management Screen>

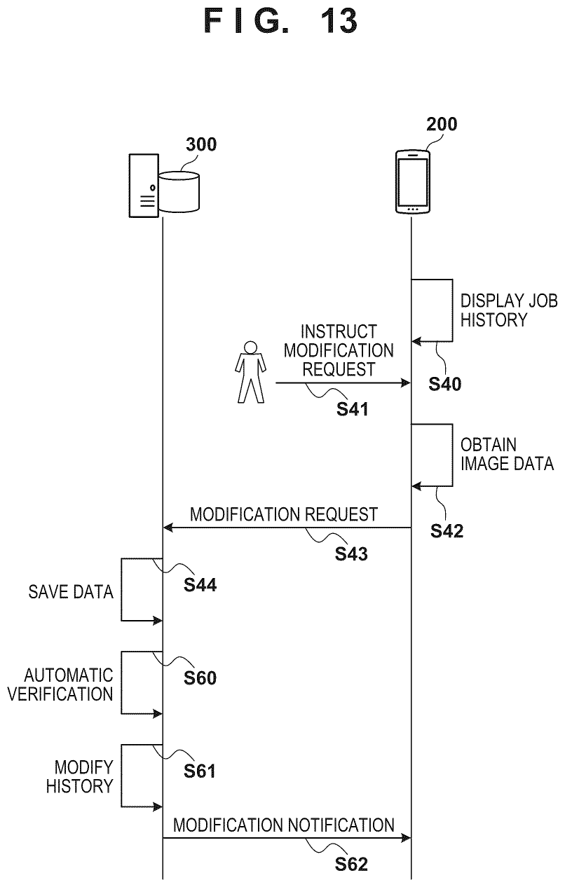

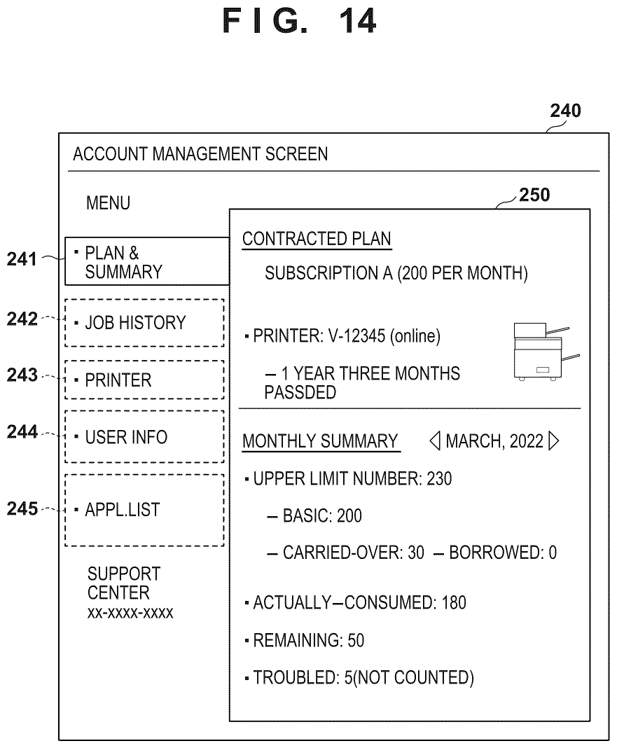

FIG. 14 illustrates an account management screen 240 that is an example of a GUI for managing an account of a subscription contract. The account management screen 240 may be invoked by a user after successful user authentication for login, for example, and displayed by the display device 215 of the user terminal 200 or the display device 24 of the image-forming apparatus 100.

Referring to FIG. 14, the account management screen 240 includes menu items 241 to 245, and an information display region 250. The menu item 241 is an item for a user to view contents of a plan selected for a contract. The menu item 242 is an item to view history of jobs executed in the past at the image-forming apparatus 100 registered as a subject of the contract. The menu item 243 is an item to view detailed information related to the image-forming apparatus 100 registered as the subject of the contract. The menu item 244 is an item to view basic information of the user registered in association with the user account. The menu item 245 is an item to view a list of applications that the user submitted to the system in the past (for example, the above-described modification request(s), application(s) for carry-over/advance borrowing, and application(s) for replacement of apparatus described below). Information contents corresponding to a menu item operated by the user are displayed in the information display region 250.

In the example of FIG. 14, the menu item 241 is selected, and the upper half of the information display region 250 displays the contents of the plan selected by the user (the plan name, the upper limit number per month, the name of the registered apparatus, and elapsed time since the start of utilizing the registered apparatus). The lower half of the information display region 250 displays a monthly summary of actual utilization of the image-forming apparatus 100 by the user. The monthly summary includes, for example, the upper limit number, details of the upper limit number (contract-based basic upper limit, carried-over portion from the previous month, and borrowed portion from the next month), the actual number of sheets, the remaining number of sheets, and the number of trouble sheets. The carried-over portion from the previous month refers to the number of sheets admitted to be added to the upper limit number of the present month out of the number of sheets left unused without being consumed at the end of the previous month (referred to as excess number). Depending on the contracted plan, a condition to admit the excess number of sheets to be carried over for up to one month may be set. The borrowed portion from the next month refers to the number of sheets admitted to be consumed by the user in advance in the present month out of the upper limit number of sheets allocated for the next month based on the contract. Depending on the contracted plan, borrowing from the next month may be admitted if there is an application from the user, for example. The actual number indicates a value derived by summing “Number of Consumed Sheets” of history data stored in the job table 330 of the management server 300, but records of which “Count?” indicates “NO” are excluded from the summation. The remaining number corresponds to a difference between the upper limit number and the actual number. The number of trouble sheets indicates the number of the sheets excluded from calculation of the actual number based on modification requests from the user. In the example of FIG. 14, the upper limit number is 230, and a total of 185 sheets have been consumed by jobs executed during the present month, but as a result of excluding five sheets affected by printing troubles based on modification requests, the actual number is 180, and the remaining number is 50. Note that, of course, an actual number of sheets before excluding the number of trouble sheets (185 sheets in the example of FIG. 14) may additionally be displayed on the account management screen 240.

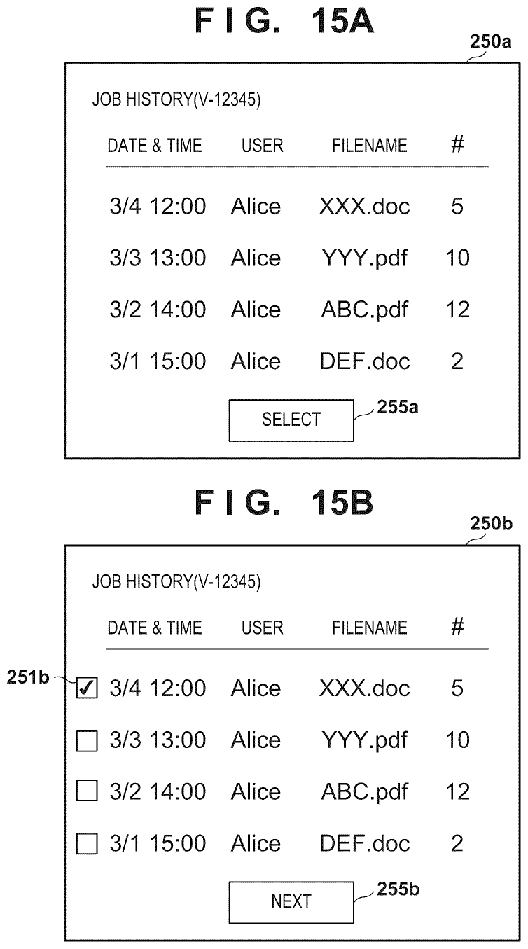

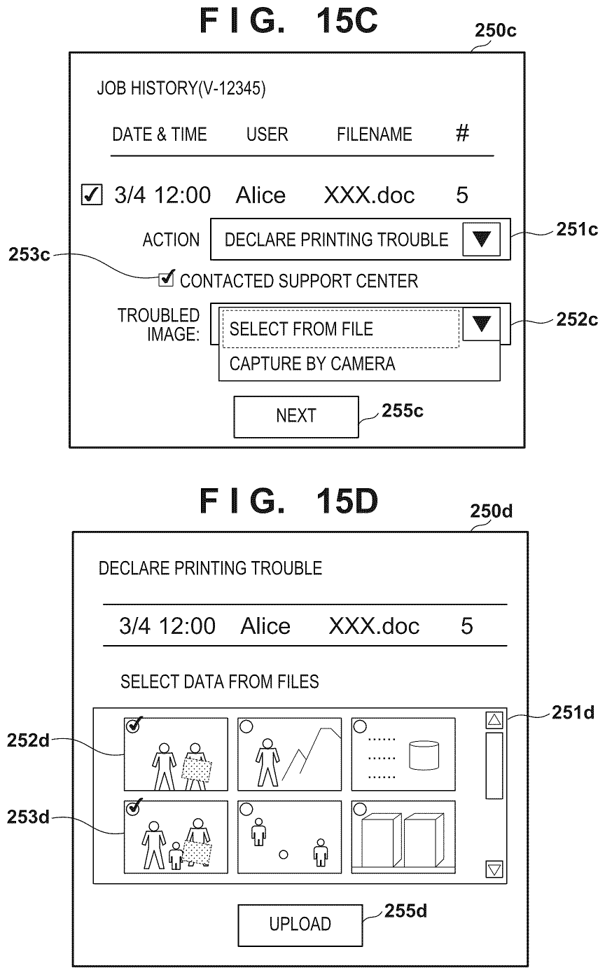

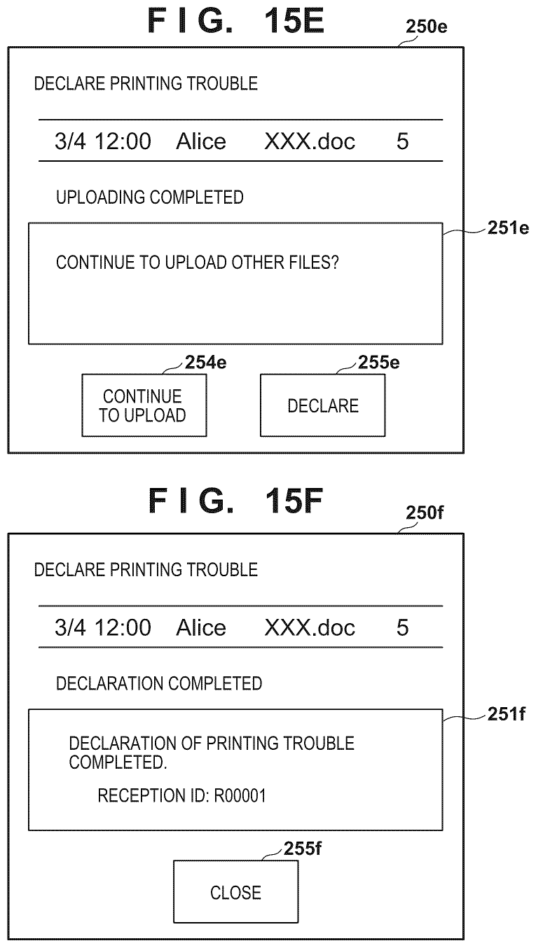

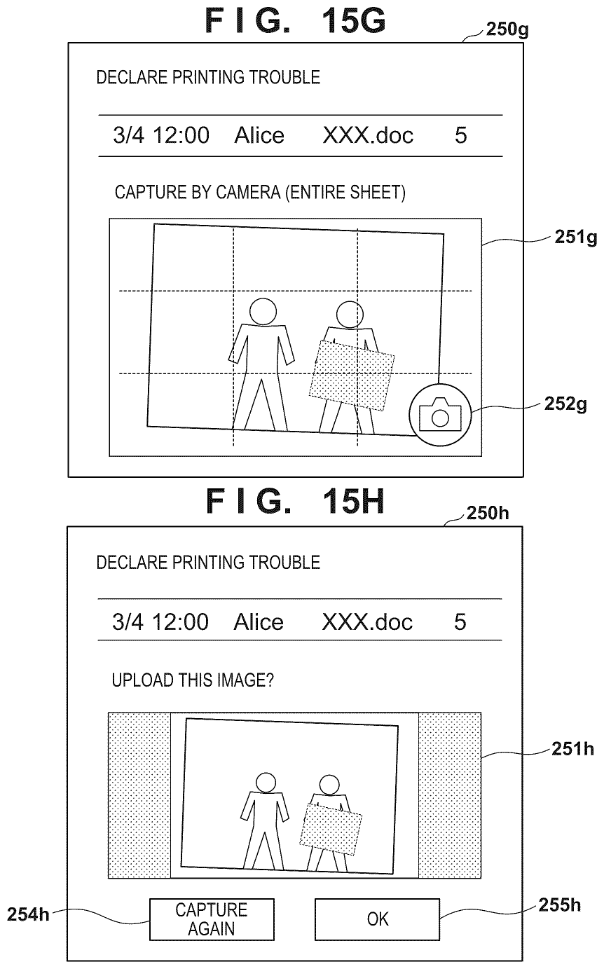

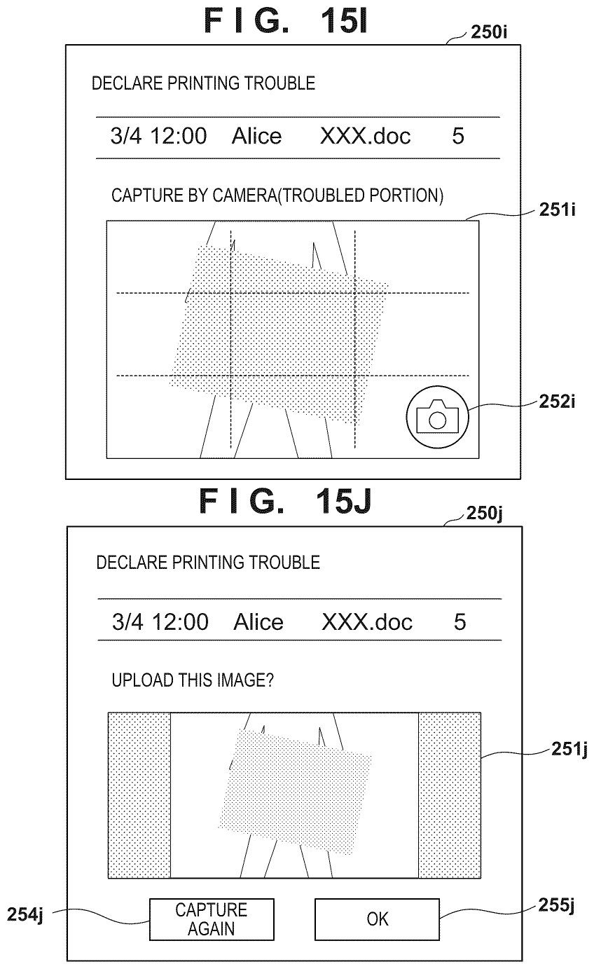

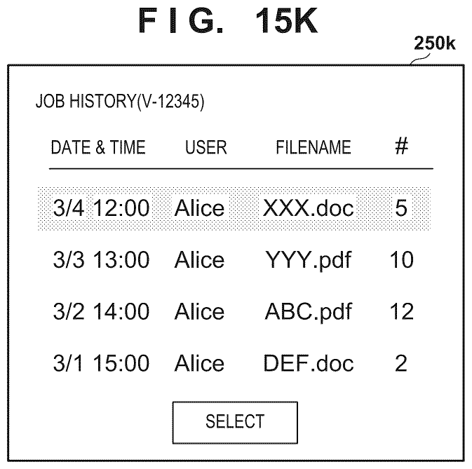

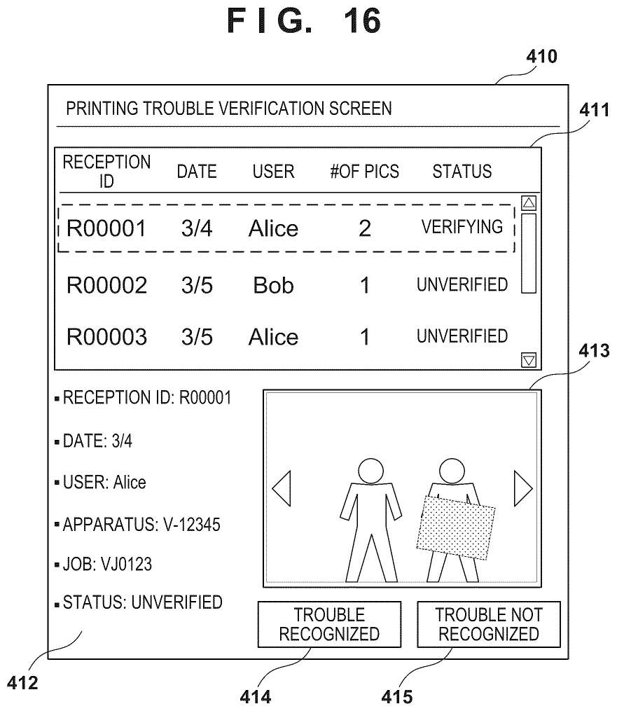

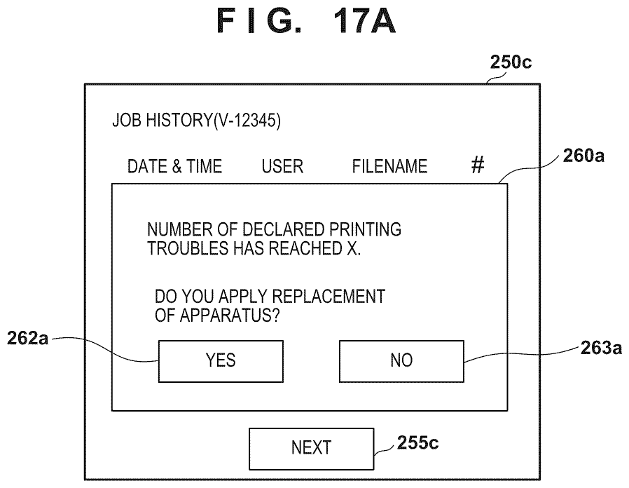

For example, if the menu item 242 of the account management screen 240 of FIG. 14 is selected, the information display region 250 displays a list of history records of jobs executed in the past as illustrated in FIG. 15A.

### <6-2. Display of Job History and Modification Request>

FIG. 15A illustrates an example of a GUI for displaying a list of job history records. In the example of FIG. 15A, the information display region 250a indicates, as history information of four jobs executed in the past at the apparatus identified by the apparatus ID “V-12345”, execution date and time, user (name of the one who issued the job), filename, and number of consumed sheets. If the user wants to exclude the number of sheets consumed in any job as a printing trouble occurred, he or she operates the button 255a. Then, the displayed contents on the screen transition to the contents illustrated in FIG. 15B.

FIG. 15B illustrates an example of a GUI for a user to select an intended item from the list of job history records. In the example of FIG. 15B, the information display region 250b indicates history information similar to that in the example of FIG. 15A, but there are respective check boxes displayed on the left side of the four items. If the job displayed at the top row has caused a printing trouble, for example, the user checks the check box 251b and operates the button 255b. Then, the displayed contents on the screen transition to the contents illustrated in FIG. 15C.

FIG. 15C illustrates an example of a GUI for enabling to request modification to history data of a selected job. In the example of FIG. 15C, the upper half of the information display region 250c displays history information of the job selected by the user. The lower half of the information display region 250c includes a pull-down menu 251c, a pull-down menu 252c, a check box 253c, and a button 255c. The pull-down menu 251c is a UI for the user to designate one of actions that can be taken for the selected history item. Herein, the action “declare printing trouble” is designated by the user. This action is an action for triggering transmission of a modification request described above, and the pull-down menu 252c and the check box 253c may be displayed when this action is selected. Alternatively, the pull-down menu 252c and the check box 253c may be disabled until the action “declare printing trouble” is selected and, in response to selection of that action, may be enabled and become operable by the user. These objects may be grayed out on the screen while they are disabled. The pull-down menu 252c is a UI for the user to designate a method for obtaining trouble image data to be transmitted with the modification request. Herein, one of two types of methods including “select from file” and “capture by camera” can be designated. The check box 253c is a UI for prompting the user to contact the support center before declaring a printing trouble. For example, if the user checks the check box 253c, designates “select from file” in the pull-down menu 252c and operates the button 255c, the displayed contents on the screen transition to the contents illustrated in FIG. 15D. Note that, in a case where the user does not check the check box 253c, the button 255c may be kept disabled, or a message that warns to contact the support center may be displayed in response to operation on the button 255c.

FIG. 15D illustrates an example of a GUI for a user to select trouble image data prepared in advance from a list of files that can be accessed in the file system. In the example of FIG. 15D, the upper half of the information display region 250d continues to display history information of the job selected by the user. The lower half of the information display region 250d includes a file selection region 251d and a button 255d. The file selection region 251d displays thumbnails of data files of image data in a list format. For example, the user selects the thumbnails 252d, 253d of two files in which printing troubles appear, and operates the button 255d. Then, the selected data files of trouble image data is uploaded to the management server, and the displayed contents on the screen transition to the contents illustrated in FIG. 15E.

FIG. 15E illustrates an example of a GUI for completing transmission of a modification request. In the example of FIG. 15E, the information display region 250e includes a message display region 251e, a button 254e, and a button 255e. The information display region 250e displays a message asking the user whether to continue uploading data files of trouble image data or to complete the procedure of declaring the printing trouble. For example, the user who intends to continue uploading operates the button 254e. Then, the displayed contents on the screen transition back to the contents illustrated in FIG. 15D. The user who intends to complete the procedure of declaring the printing trouble operates the button 255e. Then, the displayed contents on the screen transition to the contents illustrated in FIG. 15F.

FIG. 15F illustrates an example of a GUI displayed after completing transmission of the modification request. In the example of FIG. 15F, the information display region 250f includes a message display region 251f and a button 255f. The information display region 250f displays a reception ID assigned to the modification request together with a message notifying the user that the modification request has been transmitted and the procedure of declaring the printing trouble has been completed. When the user operates the button 255f, the displayed contents on the screen may go back to the list of job history records described using FIG. 15A, for example.

On the screen described using FIG. 15C, for example, the user checks the check box 253c, designates “capture by camera” in the pull-down menu 252c and operates the button 255c. Then, the camera 213 of the user terminal 200 is activated, and the displayed contents on the screen transition to the contents illustrated in FIG. 15G.

FIG. 15G illustrates an example of a GUI for a user to take an image of a sheet affected by a printing trouble. In the example of FIG. 15G, the information display region 250g includes a camera view region 251g and a shutter button 252g. For example, the user arranges the sheet in which the printing trouble appears such that the entire sheet can be seen in the camera view region 251g, and operates the shutter button 252g. Then, the camera 213 captures an image of the entire sheet to generate image data, and the displayed contents on the screen transition to the contents illustrated in FIG. 15H.

FIG. 15H illustrates an example of a GUI for asking a user for confirmation on transmitting the image data of the captured image as trouble image data. In the example of FIG. 15H, the information display region 250h includes an image display region 251h, a button 254h, and a button 255h. The image display region 251h displays an image of a sheet captured by the camera 213. For example, the user who has viewed the image displayed in the image display region 251h and intends to perform re-capturing operates the button 254h. Then, the displayed contents on the screen transition back to the contents illustrated in FIG. 15G. The user who judged that the printing trouble sufficiently appears in the image displayed in the image display region 251h operates the button 255h. Then, the displayed contents on the screen may transition to the contents similar to the contents illustrated in FIG. 15E.

In an alteration example, the modification management unit 375 of the management server 300 may request the user to transmit, as the trouble image data, image data showing an enlarged view of the trouble portion in addition to the image data of the entire sheet affected by the printing trouble.

FIG. 15I illustrates another example of a GUI for the user to capture an image of a sheet affected by a printing trouble. In the example of FIG. 15I, the information display region 250i includes a camera view region 251i and a shutter button 252i. For example, the user arranges the sheet such that the portion in which the printing trouble appears can be seen in the camera view region 251i in an enlarged manner, and operates the shutter button 252i. Then, the camera 213 captures an image of the trouble portion of the sheet to generate image data, and the displayed contents on the screen transition to the contents illustrated in FIG. 15J.

FIG. 15J illustrates another example of a GUI for asking a user for confirmation on transmitting the image data of the captured image as trouble image data. In the example of FIG. 15J, the information display region 250j includes an image display region 251j, a button 254j, and a button 255j. The image display region 251j displays an enlarged image of the trouble portion of the sheet captured by the camera 213. For example, the user who has viewed the enlarged image displayed in the image display region 251j and intends to perform re-capturing operates the button 254j. Then, the displayed contents on the screen transition back to the contents illustrated in FIG. 15I. The user who judged that the printing trouble sufficiently appears in the enlarged image displayed in the image display region 251j operates the button 255j. Then, the displayed contents on the screen may transition to the contents similar to the contents illustrated in FIG. 15E.

The modification request is transmitted to the management server 300 after the interaction through the above-described series of GUIs, and the history data of the job that caused the printing trouble is modified. Afterwards, when the user accesses the list of job history records, the contents illustrated in FIG. 15K may be displayed on the screen, for example. In the example of FIG. 15K, the information display region 250K displays execution history of four items of jobs that are similar to those in the information display region 250a of FIG. 15A. However, the item in the top row that has been excluded from calculation of the actual number of sheets based on the modification request (declaration of the printing trouble) is grayed out so that it can be discerned on the screen that the status of the corresponding history record has been modified.

### <6-3. Verification of Trouble Image Data>

FIG. 16 illustrates a printing trouble verification screen 410 that is an example of a GUI for data verification at the operator terminal 400. The printing trouble verification screen 410 may be invoked by an operator's person in charge at the operator terminal 400 and displayed by a display device of the operator terminal 400.

With reference to FIG. 16, the printing trouble verification screen 410 includes a request list region 411, a detailed information region 412, an image display region 413, a button 414, and a button 415. The request list region 411 is a region for displaying a list of modification requests for which data verification has not been completed. For example, the request list region 411 may display, for each of modification requests of which “Verification Status” in the modification request table 340 indicates “Unverified”, a reception ID, a date (reception date), a username of a requesting person, the number of trouble images in received data, and a data verification status. When the person in charge selects one of the modification requests displayed in the request list region 411, the detailed information region 412 displays detailed information related to the selected modification request, and the image display region 413 displays one of images based on the trouble image data received with the modification request. In the example of FIG. 16, the reception ID, date, username, apparatus ID of the subject image-forming apparatus 100, the job ID of the subject job, and the verification status of the selected modification request are displayed in the detailed information region 412. The person in change checks whether a printing trouble appears in the image displayed in the image display region 413, and operates the button 414 if he or she judges that a printing trouble appears. This may result in the data verification result of “Trouble Recognized” to be registered in the modification request table 340. The person in change operates the button 415 if he or she judges that no printing trouble appears in the image displayed in the image display region 413. This may result in the data verification result of “Trouble Not Recognized” to be registered in the modification request table 340.

In a practical example where exclusion from the actual number of sheets is done in a unit of a job, if it is judged that a printing trouble appears in at least one trouble image, “Verification Status” of the modification request is updated to “Trouble Recognized”, and “Count?” of the corresponding history record is set to “No”. In a practical example where exclusion from the actual number of sheets is done in a unit of a sheet, a verification result of “Trouble Recognized” or “Trouble Not Recognized” is maintained for each received trouble image, and the number of sheets judged as “Trouble Recognized” is subtracted from the value of “Number of Consumed Sheets” of the corresponding history record.

### <6-4. Application of Apparatus Replacement>

In order to ensure user's continued utilization of the service while the contract between the user and the operator is effective, the operator may receive, from the user, an application for replacement of the image-forming apparatus 100 based on a specific reason. For example, the user is provided with a UI for submitting the application for replacement at the user terminal 200 or the image-forming apparatus 100, and the management server 300 that has received the application for replacement via the UI notifies the operator terminal 400 of the application for replacement. The operator's person in charge who has received the notification arranges delivery of a new apparatus to the user (and pick-up of the old apparatus as needed).

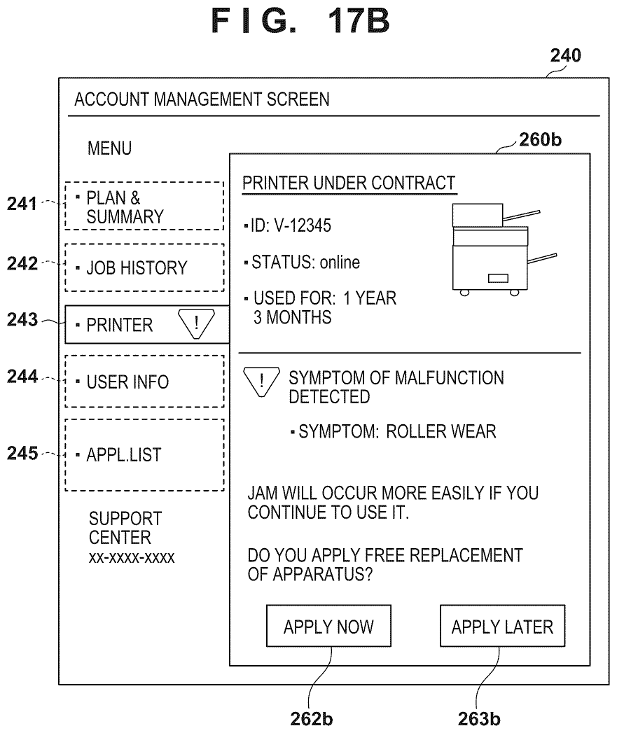

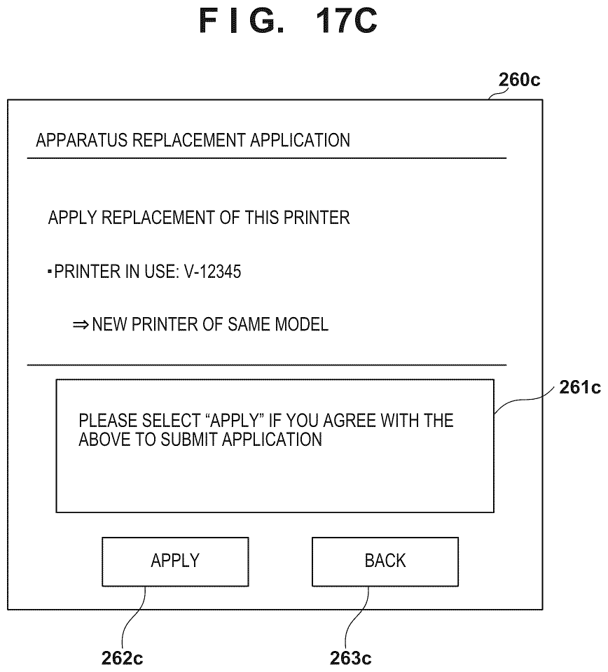

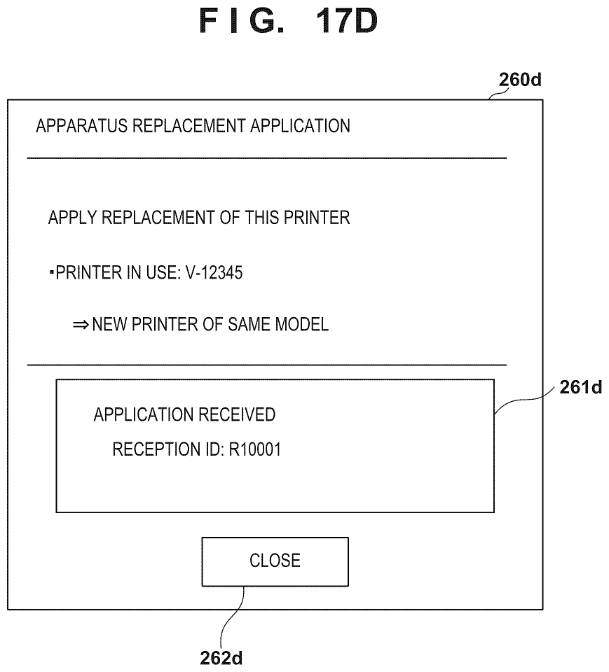

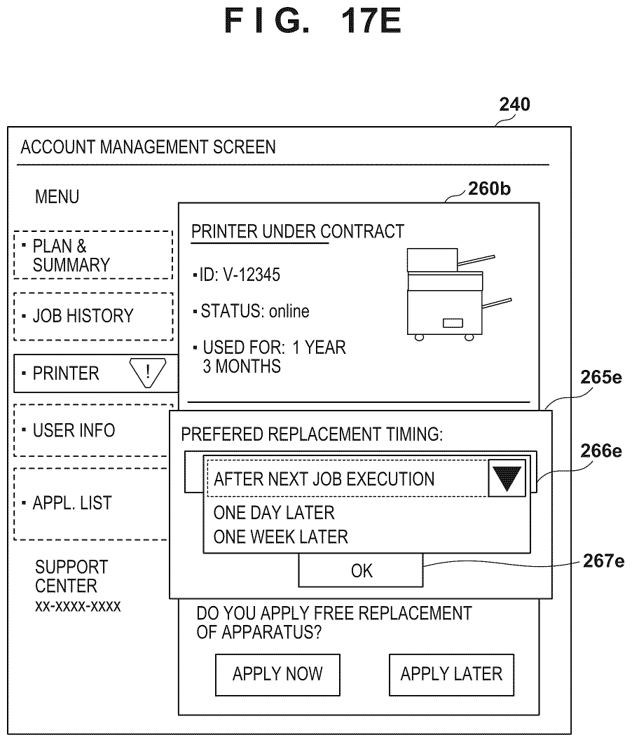

For instance, as described above, based on statistics regarding modification requests in the past, the modification management unit 375 may suggest submitting an application for replacement of the image-forming apparatus 100 to a user who intends to transmit a modification request due to occurrence of a printing trouble. The statistics regarding modification requests herein may be the number of times a modification request is received within a fixed period of time, or the cumulative number of sheets excluded from the actual number based on modification requests. FIG. 17A illustrates a first example of a GUI related to an application for replacement of the image-forming apparatus 100 with a new apparatus. Referring to FIG. 17A, a pop-up window 260a is superimposed on the information display region 250c described using FIG. 15C. The pop-up window 260a may be displayed, for example, when a user operates the button 255c to transmit a new modification request in a situation where the number of times he or she transmitted a modification request within a certain period of time in the past has already reached a threshold. The pop-up window 260a displays a message teaching that the number of declared printing troubles has reached the threshold X and suggesting replacement of the image-forming apparatus 100 with a new apparatus, and includes a button 262a and a button 263a. The user who wishes the replacement can transmit a request for the replacement to the management server 300 by operating the button 262a. The user who does not wish the replacement for the time being can close the pop-up window 260a by operating the button 263a. After the pop-up window 260a is closed, the modification management unit 375 may receive a new modification request, or may reject a new modification request unless the replacement of the apparatus is done.

As another example, the data management unit 360 may suggest the user to submit an application for replacement of the apparatus via a UI of the user terminal 200 or the image-forming apparatus 100 in a case where an abnormality detection report is received from the print control unit 110 of the image-forming apparatus 100 that has detected an occurrence of malfunction or a symptom thereof. FIG. 17B illustrates a second example of a GUI related to an application for replacement of the image-forming apparatus 100 with a new apparatus. Referring to FIG. 17B, the account management screen 240 similar to the one described using FIG. 14 is shown again, but a warning icon is added to the menu item 243. This warning icon is for drawing the user's attention to the fact that a symptom of malfunction has been detected in the image-forming apparatus 100. As a result of the user selecting the menu item 243, the information display region 260b displays detailed information related to the image-forming apparatus 100 registered in association with the user account. Specifically, the upper half of the information display region 260b displays an apparatus ID, an operation status, and elapsed time since the start of utilization of the image-forming apparatus 100. The lower half of the information display region 260b displays a message warning the user that roller wear has been detected as a symptom of malfunction and that continuing to use will increase likelihood of occurrence of jam, as well as suggesting the user to submit an application for replacement with a new apparatus. Depending on the contracted plan, the replacement of the apparatus may be free of charge or charged. In addition, the information display region 260b includes a button 262b and a button 263b. The user who wishes the replacement can transmit a request for the replacement to the management server 300 by operating the button 262b. The user who does not wish the replacement for the time being can postpone the application for replacement until a later timing by operating the button 263b. For example, when the user operates the button 262b, the displayed contents transition to the contents illustrated in FIG. 17C.

FIG. 17C illustrates an example of a GUI for a user to make a confirmation on details of an application for replacement of an apparatus. In the example of FIG. 17C, the upper half of the information display region 260c displays the apparatus ID of the image-forming apparatus 100 currently used by the user together with the details of the application to replace the apparatus being used with a new apparatus of the same model. The lower half of the information display region 260c includes a message display region 261c, a button 262c, and a button 263c. The message display region 261c displays a message notifying that the user can submit the application by operating the button 262c if the user agrees with the displayed details of the application. When the user who agrees with the details of the application operates the button 262c, a replacement request for requesting replacement of the apparatus is transmitted to the management server 300, and the displayed contents on the screen transition to the contents illustrated in FIG. 17D. On the other hand, when the user operates the button 263c, the displayed contents on the screen transition back to the contents illustrated in FIG. 17B.

FIG. 17D illustrates an example of a GUI displayed after the replacement request is transmitted to the management server 300. In the example of FIG. 17D, the upper half of the information display region 260d continues to display the details of the application for replacement of the apparatus. The lower half of the information display region 260d includes a message display region 261d, and a button 262d. The message display region 261d displays a reception ID assigned to the replacement request together with a message notifying the user that the procedure of submitting the application for replacement of the apparatus has been completed. When the user operates the button 262d, the screen illustrated in FIG. 17D may be closed.

Although not illustrated in the configuration of the management server 300 in FIG. 9, the management DB 303 may further include a table that holds information concerning the above-described replacement request received via the communication I/F 301. For example, upon receiving a replacement request, the data management unit 360 of the management server 300 transmits a replacement request notification to the operator terminal 400. Having received this replacement request notification at the operator terminal 400, the operator's person in charge may access the management server 300 to check what is requested and start a procedure to provide the user with a new apparatus.

When the user operates the button 263b on the screen illustrated in FIG. 17B, a pop-up window 265e for the user to select a timing until when the user wishes to postpone the application for replacement of the apparatus may be displayed as illustrated, for example, in FIG. 17E. The pop-up window 265e includes a pull-down menu 266e and a button 267e. The pull-down menu 266e is a UI for a user to select until when to postpone the application for replacement of the apparatus. In the example of FIG. 17E, three options, namely “After Executing Next Job”, “One Day Later” and “One Week Later” are presented in the pull-down menu 266e. When the user selects one option and operates the button 267e, a postponement notification is transmitted to the management server 300 to notify it of the postponement of replacement of the apparatus, and the pop-up window 265e illustrated in FIG. 17E may be closed. In this case, when the timing selected by the user has arrived, the screen illustrated in FIG. 17B is displayed again, and the application for replacement of the apparatus may be suggested once again.

Although an example where an application for replacement of the apparatus is suggested to the user when a symptom of malfunction is detected in the image-forming apparatus 100 has been mainly described herein, an application for replacement of the apparatus may be suggested in a similar manner when a malfunction (or an abnormality that makes it difficult to continue using the apparatus) is detected. The malfunction may include, for example, a malfunction of a member such as the fixing heater 53. The abnormality that makes it difficult to continue using the apparatus may include, for example, the amount of waste toner in the waste toner container having reached a certain ratio relative to its capacity. However, if the image-forming apparatus 100 breaks down or is difficult to be continuously used, the option for postponing the application for replacement of the apparatus may not be presented to the user. In any case, when submitting the application for replacement of the apparatus, a selectable option to replace not with a new apparatus but with a used apparatus (for example, in exchange for discounts on the fee) may be offered to the user.

It should be noted that the image-forming apparatus 100 may be capable of detecting use of a consumable material (for example, a sheet, toner, a cartridge, or the like) that is not a consumable material provided by the operator or for which compatibility with the image-forming apparatus 100 is not guaranteed. In a case where such use of a non-regular consumable material is detected, the management server 300 may cause the user terminal 200 or the image-forming apparatus 100 to issue a warning to the user. Additionally, in a case where the use of the non-regular consumable material is continued despite the warning, a subsequent replacement of the image-forming apparatus 100 or supply of a consumable material may be provided on a chargeable basis.

### 7. Summary

Various embodiments, practical examples and alteration examples of the technology according to the present disclosure have been described above using FIGS. 1 to 17E. According to the above embodiments, an image-forming system includes an image-forming apparatus arranged in a user environment and configured to execute a job to form an image on a sheet. A database is arranged in a remote environment and configured to store history data of one or more jobs executed by the image-forming apparatus. Execution of a job at the image-forming apparatus or charging to a user of the image-forming apparatus is controlled based on an actual number of sheets consumed by the image-forming apparatus calculated based on the history data. Then, in a case where a first job executed by the image-forming apparatus has caused a trouble of image-formation, a modification request including job-related information of the first job for modifying the database is transmitted in response to an instruction by a user. Based on this modification request, the database may be modified so that at least a sheet affected by the trouble is not taken into account in the actual number. According to this configuration, since a user can proactively instruct transmission of a modification request for modifying history data of a job when a subjective printing trouble appears in a printed copy, it is possible to avoid a decrease in user's satisfaction with the service. At the business operator's side, appropriate upper limit management or appropriate charging management can be ensured by verifying, before or after the modification to the history data, the modification request received from the user. Therefore, it is possible to prevent a decrease in user's satisfaction in the case of a printing trouble and, at the same time, appropriately keep track of the amount of printing.

In a practical example, determination to permit or reject execution of a job requested by a user is made so that the actual number of sheets consumed by the image-forming apparatus within a predetermined period does not exceed an upper limit number. Then, the modification request is a request that at least the sheet affected by the printing trouble be not taken into account in the actual number to be compared with the upper limit number. In this case, the user who has noticed the printing trouble can instruct transmission of the modification request in order to avoid the remaining number of sheets relative to the upper limit number from unfairly decreasing. In another practical example, an amount that depends on the actual number of sheets consumed by the image-forming apparatus within a predetermined period is charged to a user. Then, the modification request is a request that at least the sheet affected by the printing trouble be not taken into account in determining the amount to be charged. In this case, the user who has noticed the printing trouble can instruct transmission of the modification request in order to avoid the charged amount from unfairly increasing because of even the sheet affected by the printing trouble being taken into account in the actual number.

In the above-described embodiments, the modification request includes print image data of a sheet selected by the user as one affected by the printing trouble. According to this configuration, it is possible to judge at the operator's side whether or not it is recognized that a printing trouble actually occurred by verifying the image based on the print image data received with the modification request. Therefore, for example, in a case where a modification request is transmitted even though no printing trouble actually occurred, the operator can appropriately maintain the calculated value of the actual number of sheets by rejecting the modification request or canceling modification made based on the modification request.

As an example, the image-forming system may include a terminal apparatus including a capturing unit that is capable of generating the print image data by capturing an image of the selected sheet, and the modification request may be transmitted from the terminal apparatus. In this case, the user can easily take an image of a sheet that the user subjectively judged to have a printing trouble, and transmit the image data of the sheet as the print image data with the modification request. As another example, the image-forming system may include a terminal apparatus including a control unit configured to provide a user interface for the user to select the print image data in a file system, and the modification request may be transmitted from the terminal apparatus. In this case, the user can create image data of a sheet that the user subjectively judged to have a printing trouble by means of a scanner, a digital camera or the like, and transmit the created image data as the print image data with the modification request. In any case, the print image data that demonstrates the occurrence of a printing trouble can be easily transmitted from the terminal apparatus utilized by the user to the operator's side, which means that the procedure for requesting modification to the history data is simple and convenient to the user. Therefore, in a case where a printing trouble occurs, it is possible to keep a procedural burden imposed on a user small and to prevent economic detriment to the user.

In the above-described embodiments, a screen displaying history of one or more jobs executed by the image-forming apparatus is provided to the user in order for the user to instruct transmission of the modification request. Then, after the user selects the first job that has caused a printing trouble on that screen, the modification request is transmitted. Therefore, the task of the user to explain in detail to the operator the circumstances under which the printing trouble occurred can be omitted, and the procedural burden imposed on the user is even mitigated. Moreover, since the modification request is received in a manner that identifies in which job the printing trouble occurred, it is possible at the operator's side to reliably judge how to verify the data or how to modify the history data in response to receiving the modification request.

In the above-described embodiments, a management server arranged in a remote environment in the image-forming system causes the database to store the print image data in association with the modification request. This guarantees verifiability about adequacy of modification requests. If the history data is modified without waiting for the data verification in response to reception of the modification request or reception of the print image data, a user who wanted the modification for a valid reason will not feel dissatisfied due to a waiting time until the modification is made. If the history data is modified after the data verification is performed in response to reception of the modification request or reception of the print image data and it is determined that a printing trouble actually occurred, it is possible to keep determination on whether to permit execution of jobs appropriate or keep fee calculation appropriate.

The various embodiments, practical examples, and alteration examples described in this specification may be combined with each other in any way. The features described in connection with a given example, and the advantageous effects thereof are applicable to any embodiment, practical example, and alteration example unless otherwise explained.

A function described in the above-described embodiment as being implemented in one of the image-forming apparatus 100, the user terminal 200 and the management server 300 may be implemented in another apparatus. For example, the function of determining whether to permit execution of a job or computing a fee to be charged based on the actual number of consumed sheets may be implemented in the image-forming apparatus 100 or the user terminal 200 instead of the management server 300.

According to the present invention, it is possible to prevent a decrease in user's satisfaction in the case of a printing trouble and, at the same time, appropriately manage the amount of printing.

### 8. Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image-forming system comprising:
an image-forming apparatus arranged in a user environment and configured to execute a job to form an image on a sheet;
a database arranged in a remote environment and configured to store history data of one or more jobs executed by the image-forming apparatus;
a control unit configured to control execution of a job by the image-forming apparatus or control charging to a user of the image-forming apparatus based on an actual number of sheets consumed by the image-forming apparatus calculated based on the history data; and
a communication unit configured to, in a case where a first job executed by the image-forming apparatus has caused a trouble of image-formation, transmit, in response to an instruction by a user, a modification request for modifying the database so that at least a sheet affected by the trouble is not taken into account in the actual number, wherein the modification request includes job-related information of the first job.

2. The image-forming system according to claim 1, wherein the control unit is configured to permit or reject execution of a job requested by a user so that the actual number of sheets consumed by the image-forming apparatus within a predetermined period does not exceed an upper limit number, and
the modification request is a request that at least the sheet affected by the trouble be not taken into account in the actual number to be compared with the upper limit number.

3. The image-forming system according to claim 1, wherein the control unit is configured to charge, to the user, an amount that depends on the actual number of sheets consumed by the image-forming apparatus within a predetermined period, and
the modification request is a request that at least the sheet affected by the trouble be not taken into account in determining the amount to be charged.

4. The image-forming system according to claim 1, wherein the modification request includes print image data of a sheet selected by the user as one affected by the trouble.

5. The image-forming system according to claim 4, wherein the image-forming system comprises
a terminal apparatus that includes:
a capturing unit configured to generate the print image data by capturing an image of the selected sheet; and
the communication unit.

6. The image-forming system according to claim 4, wherein the image-forming system comprises
a terminal apparatus that includes:
a control unit configured to provide a user interface for the user to select the print image data in a file system; and
the communication unit.

7. The image-forming system according to claim 1, wherein the communication unit is configured to transmit the modification request in a case where the first job is selected by a user on a screen for the user to instruct transmission of the modification request, the screen displaying history of the one or more jobs executed by the image-forming apparatus.

8. The image-forming system according to claim 1, wherein the image-forming system further comprises:
a modification management unit arranged in the remote environment and configured to cause the database to store the print image data in association with the modification request received from the communication unit.

9. The image-forming system according to claim 8, wherein the modification management unit is configured to modify, in response to reception of the modification request or reception of the print image data from the communication unit, the database so that at least the sheet affected by the trouble is not taken into account in the actual number.

10. The image-forming system according to claim 8, wherein the modification management unit is configured to modify, after it is determined that the trouble has actually occurred based on verification on the print image data for the modification request received from the communication unit, the database so that at least the sheet affected by the trouble is not taken into account in the actual number.

11. The image-forming system according to claim 8, wherein the job-related information includes identification information for identifying a user who issued a job, and
the modification management unit is configured to determine whether to modify the database or not in response to a new modification request from each user based on statistics regarding modification requests in the past for each user calculated from the database.

12. The image-forming system according to claim 8, wherein the modification management unit is configured to modify the database so that a number of all sheets consumed in the first job is not taken into account in the actual number.

13. The image-forming system according to claim 8, wherein the modification management unit is configured to modify the database so that a number of sheets for which the print image data is received out of the sheets consumed in the first job is not taken into account in the actual number.

14. The image-forming system according to claim 1, wherein the job-related information includes one or both of identification information for identifying the image-forming apparatus and identification information for identifying the first job.

15. A method comprising:
causing a database to store history data of one or more jobs executed by an image-forming apparatus configured to form an image on a sheet;
controlling, by a server apparatus, execution of a job at the image-forming apparatus or charging to a user of the image-forming apparatus based on an actual number of sheets consumed by the image-forming apparatus calculated based on the history data in the database;
in a case where a first job executed by the image-forming apparatus has caused a trouble of image-formation, receiving, from the image-forming apparatus or a terminal apparatus utilized by a user of the image-forming apparatus, a modification request for not taking into account at least a sheet affected by the trouble in the actual number, the modification request being transmitted in response to an instruction by the user and including job-related information of the first job; and
in a case where the modification request is received, modifying the history data related to the first job stored in the database.

16. A server apparatus comprising:
a communication unit configured to communicate with at least one of an image-forming apparatus that executes a job to form an image on a sheet or a terminal apparatus utilized by a user of the image-forming apparatus;
a management unit configured to manage a database that stores history data of one or more jobs executed by the image-forming apparatus; and
a control unit configured to control execution of a job at the image-forming apparatus or control charging to a user of the image-forming apparatus based on an actual number of sheets consumed by the image-forming apparatus calculated based on the history data;
wherein, in a case where a first job executed by the image-forming apparatus has caused a trouble of image-formation, the communication unit is configured to receive, from the image-forming apparatus or the terminal apparatus, a modification request for not taking into account at least a sheet affected by the trouble in the actual number, the modification request being transmitted in response to an instruction by the user;
the modification request includes job-related information of the first job; and
in a case where the modification request is received by the communication unit, the management unit is configured to modify the history data related to the first job stored in the database.

17. A client apparatus that is an image-forming apparatus configured to form an image on a sheet or a terminal apparatus utilized by a user of the image-forming apparatus, the client apparatus comprising:
a communication unit configured to communicate with a server apparatus that manages, in a database, history data of one or more jobs executed by the image-forming apparatus; and
a control unit configured to control communication with the server apparatus via the communication unit;
wherein the server apparatus is configured to control execution of a job at the image-forming apparatus or control charging to a user of the image-forming apparatus based on an actual number of sheets consumed by the image-forming apparatus calculated based on the history data; and
in a case where a first job executed by the image-forming apparatus has caused a trouble of image-formation, the control unit is configured to transmit, via the communication unit to the server apparatus and in response to an instruction by a user, a modification request for modifying the database so that at least a sheet affected by the trouble is not taken into account in the actual number, the modification request including job-related information of the first job.
